(19) United States
(12) Patent Application Publication
(10) Pub. No.: US 2026/0071765 A1
(43) Pub. Date: Mar. 12, 2026

(54) AIR CONDITIONING DEVICE

(71) Applicants: DENSO CORPORATION, Kariya-city (JP); CENTRAL RESEARCH INSTITUTE OF ELECTRIC POWER INDUSTRY, Tokyo (JP)

(72) Inventors: Haruyuki NISHIJIMA, Kariya-city (JP); Yuichi KAMI, Kariya-city (JP); Atsushi INABA, Kariya-city (JP); Tomohiro HIGASHI, Tokyo (JP); Li ZHANG, Tokyo (JP); Michiyuki SAIKAWA, Tokyo (JP)

(21) Appl. No.: 19/387,336

(22) Filed: Nov. 12, 2025

Related U.S. Application Data
(63) Continuation of application No. PCT/JP2024/017765, filed on May 14, 2024.

(30) Foreign Application Priority Data
May 18, 2023 (JP) 2023-082251

(51) Int. Cl. F24F 1/0373; F24F 1/0326

(52) U.S. Cl. CPC F24F 1/0373; F24F 1/0326

(57) ABSTRACT

An air conditioning device includes a circuit switching valve that switches to a circuit in which a refrigerant circulates in an order of a heater, a refrigerant-air heat exchanger, a pressure reducer, a refrigerant-outside air heat exchanger, and a suction port of the compressor in a desorption heating mode in which heating of an air-conditioning target space is performed and moisture is desorbed from an adsorber. The circuit switching valve switches to a circuit in which the refrigerant circulates in an order of the heater, the pressure reducer, the refrigerant-outside air heat exchanger, and the suction port of the compressor, bypassing the refrigerant-air heat exchanger, in an adsorption heating mode in which the heating of the air-conditioning target space is performed and moisture is adsorbed by the adsorber. The air blower blows inside air as the blown air toward the refrigerant-air heat exchanger in the adsorption heating mode.

### CROSS REFERENCE TO RELATED APPLICATIONS

The present application is a continuation application of International Patent Application No. PCT/JP2024/017765 filed on May 14, 2024, which designated the U.S. and claims the benefit of priority from Japanese Patent Application No. 2023-082251 filed on May 18, 2023. The disclosures of all the above applications are incorporated herein.

### TECHNICAL FIELD

The present disclosure relates to an air conditioning device having an adsorber.

### BACKGROUND

A vehicle air conditioning device includes a heat exchanger having an adsorber.

### SUMMARY

According to at least one embodiment of the present disclosure, an air conditioning device includes a compressor configured to compress and discharge a refrigerant; a heater configured to heat blown air to be blown into an air-conditioning target space, using the refrigerant discharged from the compressor as a heat source; a refrigerant-air heat exchanger configured to exchange heat between the refrigerant and the blown air before being heated by the heater; a refrigerant-outside air heat exchanger configured to exchange heat between the refrigerant and outside air outside the air-conditioning target space; an outside air side pressure reducer configured to reduce a pressure of the refrigerant flowing into the refrigerant-outside air heat exchanger; a refrigerant circuit switching valve configured to switch a refrigerant circuit through which the refrigerant circulates; and an air blower configured to suck at least inside air from the air-conditioning target space and blow the inside air toward the refrigerant-air heat exchanger as the blown air. The refrigerant-air heat exchanger includes an adsorber configured to adsorb moisture contained in the blown air. In a desorption heating mode in which heating of the air-conditioning target space is performed and moisture adsorbed by the adsorber is desorbed, the refrigerant circuit switching valve switches to a circuit in which the refrigerant flowing out from the heater circulates in an order of the refrigerant-air heat exchanger, the outside air side pressure reducer, the refrigerant-outside air heat exchanger, and a suction port of the compressor. In an inside air adsorption heating mode in which the heating of the air-conditioning target space is performed and moisture is adsorbed by the adsorber, the refrigerant circuit switching valve switches to a circuit in which the refrigerant flowing out from the heater circulates in an order of the outside air side pressure reducer, the refrigerant-outside air heat exchanger, and the suction port of the compressor, bypassing the refrigerant-air heat exchanger, and the air blower blows the inside air as the blown air toward the refrigerant-air heat exchanger.

### BRIEF DESCRIPTION OF THE DRAWINGS

The details of one or more embodiments are set forth in the accompanying drawings and the description below. Other features and advantages will be apparent from the description and drawings, and from the claims.

The above object and other objects, features, and advantages of the present disclosure will become more apparent from the following detailed description with reference to the accompanying drawings.

FIG. 1 is a schematic overall configuration diagram of a vehicle air conditioning device according to a first embodiment;

FIG. 2 is a diagram showing characteristics of an adsorbent according to the first embodiment;

FIG. 3 is a block diagram showing an electric controller of the vehicle air conditioning device according to the first embodiment;

FIG. 4 is a schematic overall configuration diagram showing flows of a refrigerant and a heating medium in a desorption heating mode of the vehicle air conditioning device according to the first embodiment;

FIG. 5 is a Mollier diagram showing changes in a state of the refrigerant in the desorption heating mode of a heat pump cycle according to the first embodiment;

FIG. 6 is a schematic overall configuration diagram showing flows of a refrigerant and a heating medium in an inside air adsorption heating mode of the vehicle air conditioning device according to the first embodiment;

FIG. 7 is a Mollier diagram showing changes in a state of the refrigerant in a single inside air adsorption heating mode of the heat pump cycle according to the first embodiment;

FIG. 8 is a schematic overall configuration diagram showing flows of the refrigerant and the heating medium in a low-temperature adsorption heating mode of the vehicle air conditioning device according to the first embodiment;

FIG. 9 is a Mollier diagram showing changes in the state of the refrigerant in a single low-temperature adsorption heating mode of the heat pump cycle according to the first embodiment;

FIG. 10 is a schematic psychrometric chart showing the characteristics of the adsorbent according to the first embodiment;

FIG. 11 is a schematic overall configuration diagram of a vehicle air conditioning device according to a second embodiment;

FIG. 12 is a schematic overall configuration diagram showing flows of a refrigerant and a heating medium in a desorption heating mode of the vehicle air conditioning device according to the second embodiment;

FIG. 13 is a schematic overall configuration diagram showing flows of a refrigerant and a heating medium in an inside air adsorption heating mode of the vehicle air conditioning device according to the second embodiment;

FIG. 14 is a schematic overall configuration diagram showing flows of the refrigerant and the heating medium in a low-temperature adsorption heating mode of the vehicle air conditioning device according to the second embodiment;

FIG. 15 is a schematic overall configuration diagram of a vehicle air conditioning device according to a third embodiment;

FIG. 16 is a block diagram showing an electric controller of the vehicle air conditioning device according to the third embodiment;

FIG. 17 is a schematic overall configuration diagram showing flows of a refrigerant and a heating medium in a desorption heating mode of the vehicle air conditioning device according to the third embodiment;

FIG. 18 is a schematic overall configuration diagram showing flows of a refrigerant and a heating medium in an inside air adsorption heating mode of the vehicle air conditioning device according to the third embodiment; and

FIG. 19 is a schematic overall configuration diagram showing flows of the refrigerant and the heating medium in a low-temperature adsorption heating mode of the vehicle air conditioning device according to the third embodiment.

### DETAILED DESCRIPTION

According to a comparative example, a vehicle air conditioning device includes a heat exchanger having an adsorber. More specifically, in the vehicle air conditioning device, a heat exchanger including an adsorber that adsorbs moisture contained in a blown air is employed as an interior evaporator of a heat pump cycle device that adjusts a temperature of the blown air to be blown into a vehicle interior that is an air-conditioning target space.

In addition, in a heating mode in which heating of a vehicle interior is performed while dehumidifying the blown air, a refrigerant circuit of a heat pump cycle device is switched to a refrigerant circuit in which an interior evaporator and an exterior heat exchanger are connected in parallel to a refrigerant flow. In the vehicle air conditioning device, in the heating mode, an interior condenser of the heat pump cycle device functions as a condenser, and the interior evaporator and the exterior heat exchanger function as evaporators.

Further, in the vehicle air conditioning device, an inside air having a higher temperature and humidity than the outside air flows into the interior evaporator in the heating mode. Then, the moisture contained in the inside air is adsorbed by the adsorber in the interior evaporator. Further, the blown air dehumidified by the interior evaporator is reheated by the interior condenser and blown into the vehicle interior. At this time, in the interior condenser, the heat absorbed by the refrigerant from the outside air in the exterior heat exchanger is dissipated to the blown air to heat the blown air.

In the vehicle air conditioning device, in the heating mode, the interior evaporator and the exterior heat exchanger are connected in parallel to the refrigerant flow, and the low-pressure refrigerant flows into both the interior evaporator and the exterior heat exchanger. However, even when the low-temperature refrigerant flows into the interior evaporator more than necessary in the heating mode, an adsorption amount of moisture adsorbed by the adsorber cannot be increased, and power consumption of the compressor is increased.

That is, in the vehicle air conditioning device, when the low-temperature refrigerant flows into the interior evaporator more than necessary in the heating mode, there is a possibility that an effect of reducing the energy consumption by providing the heat exchanger having the adsorber cannot be sufficiently obtained.

In contrast, according to the present disclosure, an air conditioning device including a heat exchanger having an adsorber is capable of sufficiently reducing energy consumed when heating an air-conditioning target space while dehumidifying blown air.

According to a first aspect of the present disclosure, an air conditioning device includes a compressor configured to compress and discharge a refrigerant; a heater configured to heat blown air to be blown into an air-conditioning target space, using the refrigerant discharged from the compressor as a heat source; a refrigerant-air heat exchanger configured to exchange heat between the refrigerant and the blown air before being heated by the heater; a refrigerant-outside air heat exchanger configured to exchange heat between the refrigerant and outside air outside the air-conditioning target space; an outside air side pressure reducer configured to reduce a pressure of the refrigerant flowing into the refrigerant-outside air heat exchanger; a refrigerant circuit switching valve configured to switch a refrigerant circuit through which the refrigerant circulates; and an air blower configured to suck at least inside air from the air-conditioning target space and blow the inside air toward the refrigerant-air heat exchanger as the blown air. The refrigerant-air heat exchanger includes an adsorber configured to adsorb moisture contained in the blown air. In a desorption heating mode in which heating of the air-conditioning target space is performed and moisture adsorbed by the adsorber is desorbed, the refrigerant circuit switching valve switches to a circuit in which the refrigerant flowing out from the heater circulates in an order of the refrigerant-air heat exchanger, the outside air side pressure reducer, the refrigerant-outside air heat exchanger, and a suction port of the compressor. In an inside air adsorption heating mode in which the heating of the air-conditioning target space is performed and moisture is adsorbed by the adsorber, the refrigerant circuit switching valve switches to a circuit in which the refrigerant flowing out from the heater circulates in an order of the outside air side pressure reducer, the refrigerant-outside air heat exchanger, and the suction port of the compressor, bypassing the refrigerant-air heat exchanger, and the air blower blows the inside air as the blown air toward the refrigerant-air heat exchanger.

Accordingly, in the desorption heating mode, the blown air heated by the heater is blown into the air-conditioning target space, so that the air-conditioning target space can be heated.

Further, in the desorption heating mode, a relatively high-temperature refrigerant flowing out from the heater flows into the refrigerant-air heat exchanger. Accordingly, a temperature of the adsorber of the refrigerant-air heat exchanger can be increased to desorb the moisture adsorbed by the adsorber.

In the inside air adsorption heating mode, the moisture contained in the blown air can be adsorbed by the adsorber from which the moisture is desorbed in the desorption heating mode. Further, the blown air dehumidified by the adsorber is reheated by the heater and blown into the air-conditioning target space, so that the air-conditioning target space can be dehumidified and heated.

At this time, the air blower blows the inside air as the blown air toward the refrigerant-air heat exchanger. Therefore, it is possible to reduce the energy consumed to heat the blown air to a desired temperature in the heater as compared with the case in which the outside air is blown as the blown air.

Further, in the inside air adsorption heating mode, the refrigerant circuit switching valve switches to the refrigerant circuit in which the refrigerant bypasses the refrigerant-air heat exchanger and flows. Therefore, unnecessary energy is not consumed to cause the refrigerant to flow into the refrigerant-air heat exchanger.

As a result, according to the air conditioning device in the first aspect of the present disclosure, it is possible to sufficiently obtain the effect of reducing energy consumption by including the refrigerant-air heat exchanger having the adsorber. That is, it is possible to sufficiently reduce the energy consumed when heating the air-conditioning target space while dehumidifying the blown air.

According to a second aspect of the present disclosure, an air conditioning device includes: a compressor configured to compress and discharge a refrigerant; a high-temperature side heating medium heat exchanger configured to exchange heat between the refrigerant discharged from the compressor and a heating medium; a refrigerant pressure reducer configured to reduce a pressure of the refrigerant flowing out from the high-temperature side heating medium heat exchanger; a low-temperature side heating medium heat exchanger configured to exchange heat between the refrigerant whose pressure is reduced by the refrigerant pressure reducer and the heating medium; a high-temperature side air heat exchanger configured to exchange heat between the heating medium flowing out from at least the high-temperature side heating medium heat exchanger and blown air to be blown into an air-conditioning target space; a heating medium-outside air heat exchanger configured to exchange heat between the heating medium flowing out from at least the low-temperature side heating medium heat exchanger and outside air outside the air-conditioning target space; a heating medium-air heat exchanger configured to exchange heat between the heating medium flowing out from at least one of the high-temperature side heating medium heat exchanger and the low-temperature side heating medium heat exchanger and the blown air before being heated in the high-temperature side air heat exchanger; a heating medium circuit switching valve configured to switch a heating medium circuit through which the heating medium circulates; and an air blower configured to suck at least inside air from the air-conditioning target space and blow the inside air toward the heating medium-air heat exchanger. The heating medium-air heat exchanger includes an adsorber configured to adsorb moisture contained in the blown air. In a desorption heating mode in which heating of the air-conditioning target space is performed and the moisture adsorbed by the adsorber is desorbed, the heating medium circuit switching valve switches to a heating medium circuit in which the heating medium flowing out from the high-temperature side heating medium heat exchanger flows into the high-temperature side air heat exchanger and the heating medium-air heat exchanger. In an inside air adsorption heating mode in which the heating of the air-conditioning target space is performed and the moisture is adsorbed by the adsorber, the heating medium circuit switching valve causes the heating medium flowing out from the high-temperature side heating medium heat exchanger to flow into the high-temperature side air heat exchanger, and is simultaneously switched to a heating medium circuit in which the heating medium flowing out from the low-temperature side heating medium heat exchanger bypasses the heating medium-air heat exchanger and flows into the heating medium-outside air heat exchanger, and the air blower blows the inside air toward the heating medium-air heat exchanger.

Accordingly, in the desorption heating mode, the heating medium to be heated by the high-temperature side heating medium heat exchanger flows into the high-temperature side air heat exchanger. Further, the blown air heated by the high-temperature side air heat exchanger is blown out to the air-conditioning target space, so that the air-conditioning target space can be heated.

Further, in the desorption heating mode, the heating medium to be heated in the high-temperature side heating medium heat exchanger flows into the heating medium-air heat exchanger. Accordingly, a temperature of the adsorber of the heating medium-air heat exchanger can be increased to desorb the moisture adsorbed by the adsorber.

In the inside air adsorption heating mode, the moisture contained in the blown air can be adsorbed by the adsorber from which the moisture is desorbed in the desorption heating mode. Further, the blown air dehumidified by the adsorber is reheated by the high-temperature side air heat exchanger and blown into the air-conditioning target space, so that the air-conditioning target space can be dehumidified and heated.

At this time, the air blower blows the inside air as the blown air toward the heating medium-air heat exchanger. Therefore, it is possible to reduce the energy consumed for reheating the blown air in the high-temperature side air heat exchanger as compared with the case in which the outside air is blown as the blown air.

Further, in the inside air adsorption heating mode, a heating medium circuit switching valve switches to a heating medium circuit in which the heating medium does not flow to the heating medium-air heat exchanger. Therefore, the heating medium flows into the heating medium-air heat exchanger. No unnecessary energy is consumed.

As a result, according to the air conditioning device in the second aspect of the present disclosure, it is possible to sufficiently obtain the effect of reducing the energy consumption by including the heating medium-air heat exchanger having the adsorber. That is, it is possible to sufficiently reduce the energy consumed when heating the air-conditioning target space while dehumidifying the blown air.

Hereinafter, multiple embodiments for implementing the present disclosure will be described referring to drawings. Among the embodiments, parts that correspond to each other may be assigned the same reference numeral, and redundant explanation for the part may be omitted. When only a part of a configuration is described in an embodiment, explanations of the other parts of the configuration described in another preceding embodiment may be used. Parts may be combined among the embodiments even if it is not explicitly described that the parts can be combined. The embodiments may be partially combined even if it is not explicitly described that the embodiments can be combined, provided there is no harm in the combination.

### First Embodiment

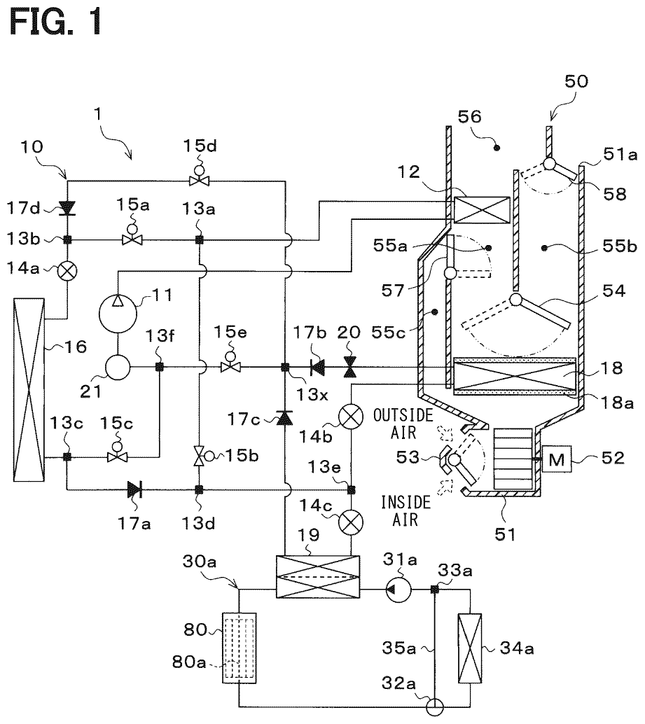

A first embodiment of an air conditioning device according to the present disclosure will be described with reference to FIGS. 1 to 10. In the present embodiment, an air conditioning device according to the present disclosure is applied to a vehicle air conditioning device 1 mounted on an electric vehicle. The vehicle air conditioning device 1 performs air conditioning of a vehicle interior, which is an air-conditioning target space, and performs temperature adjustment of an in-vehicle device. Therefore, the vehicle air conditioning device 1 can be referred to as an air conditioning device with an in-vehicle device temperature adjustment function or an in-vehicle device temperature adjustment device with an air conditioning function.

The vehicle air conditioning device 1 specifically adjusts the temperature of a battery 80 as the in-vehicle device. The battery 80 is a secondary battery that stores electric power supplied to a plurality of in-vehicle devices operated by electricity. The battery 80 is an assembled battery formed by electrically connecting a plurality of stacked battery cells in series or in parallel. The battery cell according to the present embodiment is a lithium ion battery.

The battery 80 generates heat during operation (that is, during charging and discharging). An output of the battery 80 is likely to decrease at a low temperature, and is likely to deteriorate at a high temperature. Therefore, the temperature of the battery 80 needs to be maintained within an appropriate temperature range (15° C. or more and 55° C. or lower in the present embodiment). Therefore, in the electric vehicle according to the present embodiment, the temperature of the battery 80 is adjusted using the vehicle air conditioning device 1.

As shown in the overall configuration diagram of FIG. 1, the vehicle air conditioning device 1 includes a heat pump cycle 10, a low-temperature side heating medium circuit 30a, an interior air conditioning unit 50, and the like.

First, the heat pump cycle 10 will be described. The heat pump cycle 10 is a vapor compression refrigeration cycle that adjusts the temperature of a blown air blown into a vehicle interior and the temperature of the heating medium circulating through the low-temperature side heating medium circuit 30a. The heat pump cycle 10 is implemented to be able to switch the refrigerant circuit according to each operation mode to be described later in order to perform air conditioning of the vehicle interior and temperature adjustment of the in-vehicle device.

In the heat pump cycle 10, R1234yf is employed as the refrigerant. The heat pump cycle 10 constitutes a subcritical refrigeration cycle in which a pressure of the high-pressure side refrigerant does not exceed a critical pressure of the refrigerant. A refrigerator oil for lubricating a compressor 11 is mixed in the refrigerant. The refrigerator oil is a PAG oil (that is, a polyalkylene glycol oil) having compatibility with a liquid phase refrigerant. A part of the refrigerator oil circulates in the refrigerant circuit together with the refrigerant.

First, the compressor 11 sucks, compresses, and dispenses the refrigerant in the heat pump cycle 10. The compressor 11 is an electric compressor that rotationally drives a fixed capacity type compression mechanism that has a fixed dispensing capacity by an electric motor. A rotation speed (that is, a refrigerant dispensing capacity) of the compressor 11 is controlled by a control signal output from a control device 70 described later.

The compressor 11 is disposed in a drive device chamber formed on a front side of a vehicle cabin. The drive device chamber forms a space in which at least a part of a device (for example, an electric motor for traveling) or the like used for generating or adjusting a driving force for vehicle traveling is disposed. Therefore, the space formed by the drive device chamber is outside the vehicle cabin (that is, outside an air-conditioning target space).

A refrigerant inlet side of an interior condenser 12 is connected to a dispensing port of the compressor 11. The interior condenser 12 is disposed in an air conditioning case 51 of the interior air conditioning unit 50 to be described later. The interior condenser 12 is a heating heat exchanger that exchanges heat between a discharged refrigerant discharged from the compressor and the blown air passing through an interior evaporator 18 to be described later. In the interior condenser 12, the heat of the discharged refrigerant is dissipated to the blown air to heat the blown air.

Therefore, the interior condenser 12 is a heater that heats the blown air using the discharged refrigerant discharged from the compressor 11 as a heat source.

An inflow port side of a first three-way joint 13a is connected to a refrigerant outlet of the interior condenser 12. The first three-way joint 13a has three inflow and outflow ports communicating with each other. As the first three-way joint 13a, a joint portion formed by joining a plurality of pipes or a joint portion formed by providing a plurality of refrigerant passages in a metal block or a resin block can be employed.

Further, as described later, the heat pump cycle 10 includes a second three-way joint 13b to a sixth three-way joint 13f. The basic configuration of the second three-way joint 13b to the sixth three-way joint 13f is similar to that of the first three-way joint 13a. The basic configuration of each of the three-way joints described in the embodiments to be described later is also the same as that of the first three-way joint 13a.

In the three-way joint, when one of the three inflow and outflow ports is used as an inflow port and the other two are used as outflow ports, the three-way joint serves as a branch portion that branches the flow of the refrigerant. In the three-way joint, when two of the three inflow and outflow ports are used as the inflow ports and the remaining one is used as the outflow port, the three-way joint serves as a merging portion that merges the flows of the refrigerant.

One inflow port side of the second three-way joint 13b is connected to one outflow port of the first three-way joint 13a via a first on-off valve 15a. One inflow port side of the fourth three-way joint 13d is connected to the other outflow port of the first three-way joint 13a via a second on-off valve 15b.

The first on-off valve 15a is an on-off valve that opens and closes a refrigerant flow path from one outflow port of the first three-way joint 13a to one inflow port of the second three-way joint 13b. The first on-off valve 15a is an electromagnetic valve whose opening and closing operation is controlled by a control voltage output from the control device 70.

The second on-off valve 15b is an on-off valve that opens and closes a refrigerant flow path from the other outflow port of the first three-way joint 13a to one inflow port of the fourth three-way joint 13d. The basic configuration of the second on-off valve 15b is similar to that of the first on-off valve 15a.

Further, as described later, the heat pump cycle 10 includes the third on-off valve 15c to the fifth on-off valve 15e. The basic configuration of the third on-off valve 15c to the fifth on-off valve 15e is similar to that of the first three-way joint 13a. The first on-off valve 15a to the fifth on-off valve 15e can switch the refrigerant circuit by opening and closing the refrigerant flow path. Therefore, the first on-off valve 15a to the fifth on-off valve 15e are refrigerant circuit switching valves.

An outflow port of the second three-way joint 13b is connected to an inlet side of a heating expansion valve 14a. The heating expansion valve 14a is an outside air side pressure reducer that reduces the pressure of the refrigerant flowing into the exterior heat exchanger 16 in a heating mode to be described later or the like. Further, the heating expansion valve 14a is an outside air flow rate adjustment part that adjusts a flow rate (in the present embodiment, a mass flow rate) of the refrigerant flowing into the exterior heat exchanger 16.

The heating expansion valve 14a is an electric variable throttle mechanism including a valve body portion that changes an opening degree (that is, a valve opening degree) of a throttle passage and an electric actuator (specifically, a stepping motor) that displaces the valve body portion. An operation of the heating expansion valve 14a is controlled by a control signal (specifically, a control pulse) output from the control device 70.

The heating expansion valve 14a has a fully open function of functioning as a simple refrigerant passage with almost no refrigerant pressure reduction action and flow rate adjustment action when the valve opening degree is fully opened. The heating expansion valve 14a may have a fully closed function in which the valve body portion fully closes the throttle passage, thereby blocking the refrigerant passage.

Further, as described later, the heat pump cycle 10 includes a cooling expansion valve 14b and a cooling expansion valve 14c. The basic configuration of the cooling expansion valve 14b and the cooling expansion valve 14c is the same as that of the heating expansion valve 14a. The cooling expansion valve 14b and the cooling expansion valve 14c have a fully open function and a fully closed function.

The cooling expansion valve 14b and the cooling expansion valve 14c can switch the circuit configuration of the refrigerant circuit by exhibiting the fully closed function. Therefore, the cooling expansion valve 14b and the cooling expansion valve 14c also function as a refrigerant circuit switching valve.

Of course, the cooling expansion valve 14b and the cooling expansion valve 14c may be formed by combining a variable throttle mechanism that does not have the fully closed function and an on-off valve that opens and closes the throttle passage. In this case, the on-off valve serves as the refrigerant circuit switching valve.

The refrigerant inlet side of the exterior heat exchanger 16 is connected to an outlet of the heating expansion valve 14a. The exterior heat exchanger 16 is a refrigerant-outside air heat exchanger that exchanges heat between the refrigerant flowing out from the heating expansion valve 14a and outside air blown by an outside air fan (not shown). The exterior heat exchanger 16 is disposed on a front side of the drive device chamber. Therefore, when a vehicle is traveling, a traveling wind flowing into the drive device chamber through a grille can be applied to the exterior heat exchanger 16.

The refrigerant outlet of the exterior heat exchanger 16 is connected to the inlet side of the third three-way joint 13c. The other inflow port side of the fourth three-way joint 13d is connected to one outflow port of the third three-way joint 13c via a first check valve 17a. One inflow port side of the sixth three-way joint 13f is connected to the other outflow port of the third three-way joint 13c via the third on-off valve 15c.

The third on-off valve 15c is an on-off valve that opens and closes a refrigerant flow path from the other outflow port of the third three-way joint 13c to one inflow port of the sixth three-way joint 13f. The refrigerant flow path from the other outflow port of the third three-way joint 13c to one inflow port of the sixth three-way joint 13f is a refrigerant bypass passage that guides the refrigerant flowing out from the exterior heat exchanger 16 to a suction port side of the compressor 11 while bypassing the interior evaporator 18 in the desorption heating mode to be described later.

The first check valve 17a allows the refrigerant to flow from a third three-way joint 13c side to a fourth three-way joint 13d side, and prohibits the refrigerant from flowing from the fourth three-way joint 13d side to the third three-way joint 13c side. The outflow port of the fourth three-way joint 13d is connected to an inflow port side of the fifth three-way joint 13e.

One outflow port of the fifth three-way joint 13e is connected to an inlet side of the cooling expansion valve 14b. The other outflow port of the fifth three-way joint 13e is connected to an inlet side of the cooling expansion valve 14c.

The cooling expansion valve 14b is a refrigerant-air side pressure reducer that reduces a pressure of the refrigerant flowing into the interior evaporator 18 in a cooling mode or the like. Further, the cooling expansion valve 14b is a refrigerant-air side flow rate adjustment part that adjusts a flow rate of the refrigerant flowing into the interior evaporator 18.

A refrigerant inlet side of the interior evaporator 18 is connected to an outlet of the cooling expansion valve 14b. The interior evaporator 18 is disposed in the air conditioning case 51 of the interior air conditioning unit 50 and on the air flow upstream side than the interior condenser 12.

The interior evaporator 18 is a refrigerant-air heat exchanger that exchanges heat between a low-pressure refrigerant whose pressure is reduced by the cooling expansion valve 14b and the blown air before being heated by the interior condenser 12. The interior evaporator 18 cools the blown air by evaporating the low-pressure refrigerant to exhibit a heat absorption action in a cooling mode or the like.

In the present embodiment, a so-called tank-and-tube heat exchanger is employed as the interior evaporator 18. The tank-and-tube heat exchanger includes a plurality of refrigerant tubes and a pair of refrigerant tanks.

The refrigerant tube is a metal tube through which the refrigerant flows. The plurality of refrigerant tubes are stacked at intervals in a predetermined direction. Further, an air passage through which the blown air flows is formed between the adjacent tubes. Heat exchange fins that promote heat exchange between the refrigerant and the blown air are disposed in the air passage. The heat exchange fin is a corrugated fin formed by bending a thin metal plate into a corrugated shape.

The refrigerant tank is a bottomed tubular member made of metal and extending in a stacking direction of the plurality of refrigerant tubes. A pair of refrigerant tanks are connected to both ends of the refrigerant tube, respectively. A distribution space for distributing the refrigerant to the plurality of refrigerant tubes and a collection space for collecting the refrigerant flowing out from the plurality of refrigerant tubes are formed inside the refrigerant tank.

Therefore, in the tank-and-tube heat exchanger, a heat exchange core part that exchanges heat between the refrigerant and the blown air is formed mainly by the refrigerant tubes and the heat exchange fins. Further, a solid layer of an adsorbent 18a is disposed on an outer surface of the heat exchange core part of the interior evaporator 18. The adsorbent 18a is an adsorber that contains zeolite as a main component and adsorbs moisture contained in the blown air. That is, the interior evaporator 18 has an adsorber.

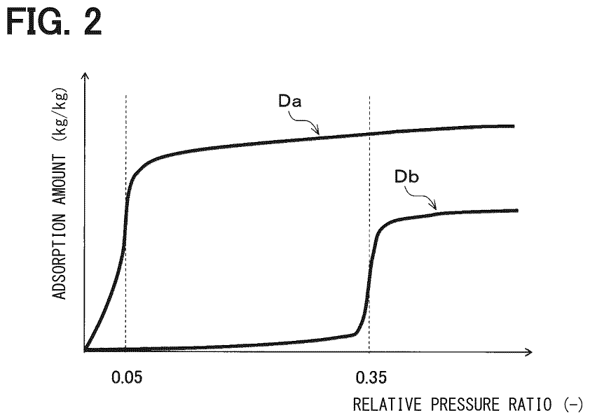

In the present embodiment, as shown in FIG. 2, the adsorbent 18a has a maximum relative pressure ratio Rmax satisfying the following formula F1.

0.05≤R max≤0.35 (F1)

The maximum relative pressure ratio Rmax is a relative pressure ratio at which an increase amount of an adsorption amount of the adsorbent 18a is maximized when the relative pressure ratio is slightly increased. The relative pressure ratio is defined as a ratio of a water vapor partial pressure of air surrounding the adsorbent 18a to a saturated water vapor pressure at a temperature of the adsorbent 18a. Therefore, the relative pressure ratio is a parameter corresponding to a relative humidity. The adsorption amount is defined by a weight (kg) of moisture that can be adsorbed by 1 kg of the adsorbent 18a.

In other words, the maximum relative pressure ratio Rmax can be defined as a relative pressure ratio at which a ratio of the increase amount of the adsorption amount to the increase amount of the relative pressure ratio is maximized. That is, the maximum relative pressure ratio Rmax can be defined as a relative pressure ratio at which a differential value becomes a maximum value when the adsorption amount is represented by a function of the relative pressure ratio and differentiated with respect to the relative pressure ratio.

In the present embodiment, specifically, an adsorbent having isothermal adsorption characteristics corresponding to AQSOA (registered trademark) Z05 or Z02 is employed as the adsorbent 18a.

As the adsorbent 18a, crystalline aluminophosphates (ALPO-based zeolite) containing at least aluminum and phosphorus in a skeleton structure are preferably employed. A binder of the adsorbent 18a contains an epoxy resin, and a dry weight of the binder is preferably 0.5% or more and 40% or less with respect to a weight of the adsorbent 18a.

FIG. 2 also shows adsorption characteristics at 25° C. of two types of adsorbers, i.e., an adsorbent Da having the maximum relative pressure ratio Rmax of about 0.05 and an adsorbent Db having the maximum relative pressure ratio Rmax of about 0.35. An adsorption speed (kg/s) of the adsorbent 18a depends on the adsorption characteristics of the adsorbent 18a. The adsorption speed (kg/s) of the adsorbent 18a tends to increase as the maximum relative pressure ratio Rmax decreases.

One inflow port side of a four-way joint 13x is connected to the refrigerant outlet of the interior evaporator 18 via an evaporation pressure adjustment valve 20 and a second check valve 17b.

The evaporation pressure adjustment valve 20 maintains a refrigerant evaporation pressure of the interior evaporator 18 at a predetermined set pressure or more in order to reduce frost formation on the interior evaporator 18. The evaporation pressure adjustment valve 20 is implemented by a mechanical mechanism that increases the valve opening degree as a refrigerant pressure on a refrigerant outlet side of the interior evaporator 18 increases.

The second check valve 17b allows the refrigerant to flow from an interior evaporator 18 side to a four-way joint 13x side, and prohibits the refrigerant from flowing from the four-way joint 13x side to the interior evaporator 18 side. The four-way joint 13x is a joint portion having four inflow and outflow ports communicating with each other. As the four-way joint 13x, a joint portion formed similarly to the three-way joint can be employed.

The cooling expansion valve 14c is a refrigerant pressure reducer that reduces a pressure of the refrigerant flowing into a chiller 19 in an operation mode in which the battery 80 is cooled using a cooling capacity of the heat pump cycle 10. The cooling expansion valve 14c is a refrigerant flow rate adjustment part that adjusts a flow rate of the refrigerant flowing into the chiller 19.

The outlet of the cooling expansion valve 14c is connected to the inlet side of the refrigerant passage of the chiller 19. The chiller 19 includes a refrigerant passage through which the low-pressure refrigerant whose pressure is reduced by the cooling expansion valve 14c flows, and a heating medium passage through which the heating medium circulating through the low-temperature side heating medium circuit 30a flows.

The chiller 19 is a low-temperature side heating medium heat exchanger that exchanges heat between the low-pressure refrigerant flowing through the refrigerant passage and the heating medium flowing through the heating medium passage. In the chiller 19, the heating medium is cooled by evaporating the low-pressure refrigerant to exhibit a heat absorption action.

An outlet of the refrigerant passage of the chiller 19 is connected to another inflow port side of the four-way joint 13x via a third check valve 17c. The third check valve 17c allows the refrigerant to flow from a chiller 19 side to the four-way joint 13x side, and prohibits the refrigerant from flowing from the four-way joint 13x side to the chiller 19 side.

One outflow port of the four-way joint 13x is connected to the other inflow port side of the second three-way joint 13b via a fourth on-off valve 15d and a fourth check valve 17d.

The fourth on-off valve 15d is an on-off valve that opens and closes a refrigerant flow path from one outflow port of the four-way joint 13x to the other inflow port of the second three-way joint 13b. The fourth check valve 17d allows the refrigerant to flow from the four-way joint 13x side to the second three-way joint 13b side, and prohibits the refrigerant from flowing from the second three-way joint 13b side to the four-way joint 13x side.

The other outflow port of the four-way joint 13x is connected to another inflow port side of the sixth three-way joint 13f via the fifth on-off valve 15e. The fifth on-off valve 15e is an on-off valve that opens and closes a refrigerant flow path from another outflow port of the four-way joint 13x to the other inflow port of the sixth three-way joint 13f.

The inlet side of an accumulator 21 is connected to an outflow port of the sixth three-way joint 13f. The accumulator 21 is a low-pressure side gas-liquid separator that separates gas and liquid of the low-pressure refrigerant flowing out from the sixth three-way joint 13f and stores the separated liquid phase refrigerant as surplus refrigerant in a cycle. A suction port side of the compressor 11 is connected to a gas phase refrigerant outlet of the accumulator 21.

Next, the low-temperature side heating medium circuit 30a will be described. The low-temperature side heating medium circuit 30a is a circuit that circulates the heating medium. In the present embodiment, an ethylene glycol aqueous solution is employed as the heating medium. A low-temperature side heating medium pump 31a, a heating medium passage of the chiller 19, a coolant passage 80a of the battery 80, a low-temperature side heating medium three-way valve 32a, a low-temperature side radiator 34a, and the like are disposed in the low-temperature side heating medium circuit 30a.

The low-temperature side heating medium pump 31a is a heating medium pumping part that sucks the heating medium flowing out from the heating medium three-way joint 33a and pumps the heating medium to the heating medium passage of the chiller 19. The low-temperature side heating medium pump 31a is an electric water pump whose rotation speed (that is, a pumping capacity) is controlled by a control voltage output from the control device 70.

An inlet side of the coolant passage 80a of the battery 80 is connected to an outlet of the heating medium passage of the chiller 19. The coolant passage 80a of the battery 80 is a heating medium passage for cooling the battery 80 by circulating the heating medium flowing out from the chiller 19. In other words, the coolant passage 80a is a battery cooling heat exchanger that cools the battery 80 by exchanging heat between the heating medium flowing through a heating medium flow path and the battery cell.

The coolant passage 80a is formed inside a battery-dedicated case that accommodates a plurality of battery cells that are stacked. The coolant passage 80a has a passage configuration in which a plurality of passages are connected in parallel inside the battery-dedicated case. Thus, in the coolant passage 80a, all the battery cells can be uniformly cooled.

An inflow port side of the low-temperature side heating medium three-way valve 32a is connected to an outlet of the coolant passage 80a of the battery 80. The low-temperature side heating medium three-way valve 32a is an electric three-way flow rate adjustment valve that has one inflow port and two outflow ports and is capable of continuously adjusting a passage area ratio of the two outflow ports. The operation of the low-temperature side heating medium three-way valve 32a is controlled by a control signal output from the control device 70.

One inflow port side of the heating medium three-way joint 33a is connected to one outflow port of the low-temperature side heating medium three-way valve 32a via a radiator bypass passage 35a. A heating medium inlet side of the low-temperature side radiator 34a is connected to the other outflow port of the low-temperature side heating medium three-way valve 32a.

The low-temperature side heating medium three-way valve 32a can cause the entire flow rate of the heating medium flowing into the low-temperature side heating medium three-way valve 32a to flow out to either a low-temperature side radiator 34a side or a radiator bypass passage 35a side. Therefore, the low-temperature side heating medium three-way valve 32a also functions as a heating medium circuit switching valve that switches the circuit configuration of the low-temperature side heating medium circuit 30a.

The low-temperature side radiator 34a is a heating medium-outside air heat exchanger that exchanges heat between the heating medium flowing out from the coolant passage 80a of the battery 80 and outside air blown by an outside air fan (not shown). The low-temperature side radiator 34a is disposed on a front side in the drive device chamber. Therefore, when the vehicle is traveling, a traveling wind can be applied to the low-temperature side radiator 34a. The low-temperature side radiator 34a may be formed integrally with the exterior heat exchanger 16.

The other inflow port side of the heating medium three-way joint 33a is connected to the heating medium outlet of the low-temperature side radiator 34a. The basic configuration of the heating medium three-way joint 33a is similar to that of the first three-way joint 13a for the refrigerant. The basic configuration of each heating medium three-way joint described in the embodiments described later is also the same as that of the heating medium three-way joint 33a. A suction port side of the low-temperature side heating medium pump 31a is connected to the outflow port of the heating medium three-way joint 33a.

Next, the interior air conditioning unit 50 will be described. The interior air conditioning unit 50 is a unit in which various components are integrated in order to blow out the blown air adjusted to an appropriate temperature for air conditioning of the vehicle interior to an appropriate location in the vehicle interior. The interior air conditioning unit 50 is disposed inside an instrument panel at a foremost portion of the vehicle interior.

The interior air conditioning unit 50 includes the air conditioning case 51 that forms an air passage therein through which the blown air flows. A blower 52, the interior evaporator 18, the interior condenser 12, and the like are disposed in the air passage formed in the air conditioning case. The air conditioning case 51 is formed of a resin (for example, polypropylene) having a certain degree of elasticity and excellent strength.

An inside and outside air switching device 53 is disposed at a most upstream portion of the air conditioning case 51 in an air flow direction. The inside and outside air switching device 53 is an inside and outside air ratio adjustment part capable of continuously adjusting a ratio between the inside air and the outside air in the blown air introduced into the air conditioning case 51. The inside air is air flowing out from the vehicle interior, which is an air-conditioning target space. The outside air is air outside the vehicle cabin. The operation of the inside and outside air switching device 53 is controlled by a control signal output from the control device 70.

The blower 52 is disposed on the air flow downstream side of the inside and outside air switching device 53. The blower 52 is an air blower that blows air sucked via the inside and outside air switching device 53 toward the vehicle interior. The rotation speed (that is, a blowing capacity) of the blower 52 is controlled by a control voltage output from the control device 70. When the inside air is introduced via the inside and outside air switching device 53, the blower 52 can suck the inside air and blow the inside air toward the vehicle interior.

The interior evaporator 18 is disposed on the air flow downstream side of the blower 52. Further, a heating passage 55a and a cold air bypass passage 55b are formed on the air flow downstream side of the interior evaporator 18 in the air conditioning case 51.

The interior condenser 12 is disposed in the heating passage 55a. Therefore, the heating passage 55a is an air passage through which the blown air passing through the interior evaporator 18 further passes through the interior condenser 12 and flows downstream. The cold air bypass passage 55b is an air passage through which the blown air passing through the interior evaporator 18 bypasses the interior condenser 12 and flows downstream.

An air mix door 54 is disposed in an air passage on an air flow downstream side of the interior evaporator 18 and on an air flow upstream side of the heating passage 55a and the cold air bypass passage 55b.

The air mix door 54 is an air volume ratio adjustment part that adjusts an air volume ratio between an air volume flowing into the heating passage 55a and an air volume flowing into the cold air bypass passage 55b in the blown air passing through the interior evaporator 18. The operation of the actuator for driving the air mix door 54 is controlled by a control signal output from the control device 70.

A mixing space 56 is formed on the air flow downstream side of the heating passage 55a and the cold air bypass passage 55b in the air conditioning case 51. The mixing space 56 is a space for mixing the blown air heated by the interior condenser 12 disposed in the heating passage 55a and the blown air that passes through the cold air bypass passage 55b but is not heated.

Therefore, in the interior air conditioning unit 50, the air mix door 54 adjusts the air volume ratio to adjust the temperature of the blown air (that is, conditioned air) mixed in the mixing space 56 and blown into the vehicle interior.

Further, a plurality of opening holes for blowing out the blown air mixed and temperature-adjusted in the mixing space 56 into the vehicle interior are formed in a most downstream portion of the air conditioning case 51 in the air flow direction.

As the plurality of opening holes, a face opening hole, a foot opening hole, and a defroster opening hole (all not shown) are provided. The face opening hole is an opening hole for blowing out the conditioned air toward an upper body of an occupant in the vehicle interior. The foot opening hole is an opening hole for blowing out the conditioned air toward feet of the occupant. The defroster opening hole is an opening hole for blowing out the conditioned air toward an inner surface of window glass on a front surface of the vehicle.

A face door, a foot door, and a defroster door (all not shown) are disposed on the air flow upstream side of the face opening hole, the foot opening hole, and the defroster opening hole, respectively. The face door adjusts an opening area of the face opening hole. The foot door adjusts an opening area of the foot opening hole. The defroster door adjusts an opening area of the defroster opening hole.

The face door, the foot door, and the defroster door are air outlet mode switching parts that switch air outlet modes. These doors are connected to a common electric actuator for driving an air outlet mode door via a link mechanism or the like, and are rotated in conjunction with each other. The operation of the electric actuator for driving the air outlet mode door is controlled by a control signal output from the control device 70.

Therefore, in the interior air conditioning unit 50, the air outlet mode switching part switches the opening hole which is opened and closed to switch the air outlet mode, so that conditioned air can be blown out from the mixing space 56 to an appropriate location in the vehicle interior.

Further, an outside air bypass passage 55c is formed in the air conditioning case 51. The outside air bypass passage 55c is a passage that guides the blown air blown from the blower 52 to an upstream side of the interior condenser 12 in the heating passage 55a while bypassing the interior evaporator 18.

An auxiliary outside air door 57 that opens and closes the outside air bypass passage 55c is disposed at a most downstream portion of the outside air bypass passage 55c in the air flow direction. The operation of the actuator for driving the auxiliary outside air door 57 is controlled by a control signal output from the control device 70.

An exhaust door 58 that opens and closes an exhaust port 51a is disposed at a most downstream portion of the cold air bypass passage 55b in the air flow direction. The exhaust port 51a is an opening hole for discharging the blown air flowing through the cold air bypass passage 55b to the outside of the vehicle cabin.

The exhaust door 58 can adjust an air volume ratio between an air volume flowing into the mixing space 56 and an air volume discharged to the outside of the vehicle cabin in the blown air flowing through the cold air bypass passage 55b. The exhaust door 58 can also cause an amount of blown air among a total air volume that is flowing into the cold air bypass passage 55b to flow out to either the mixing space 56 or the outside of the vehicle cabin. The operation of the actuator for driving the exhaust door 58 is controlled by a control signal output from the control device 70.

Next, an electric controller of the vehicle air conditioning device 1 will be described. The control device 70 includes a well-known microcomputer including a CPU, a ROM, a RAM, and the like, and peripheral circuits thereof. The control device 70 performs various kinds of calculation and processing based on a control program stored in the ROM. Further, the control device 70 controls the operation of various control target devices connected to an output side based on calculation and processing results.

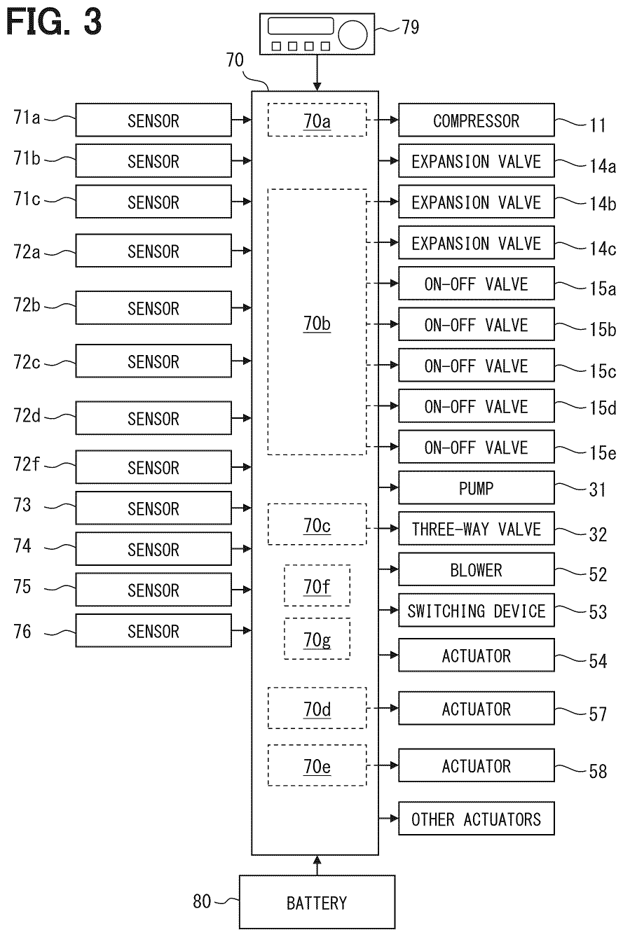

As shown in a block diagram of FIG. 3, a sensor group for control is connected to an input side of the control device 70. Detection signals of the sensor group for control are input to the control device 70. Each sensor will be described below.

An inside air temperature sensor 71a is an inside air temperature detection part that detects a vehicle interior temperature (inside air temperature) Tr. An outside air temperature sensor 71b is an outside air temperature detection part that detects a vehicle exterior temperature (outside air temperature) Tam. A solar radiation amount sensor 71c is a solar radiation amount detection part that detects a solar radiation amount As emitted into the vehicle interior.

A discharged refrigerant temperature and pressure sensor 72a is a discharged refrigerant temperature and pressure detection part that detects a discharged refrigerant temperature Td and a discharged refrigerant pressure Pd of the discharged refrigerant discharged from the compressor 11.

A high-pressure side refrigerant temperature and pressure sensor 72b is a high-pressure side refrigerant temperature and pressure detection part that detects a high-pressure side refrigerant temperature T1 and a high-pressure side refrigerant pressure P1 of the refrigerant flowing out from the heater. The high-pressure side refrigerant temperature and pressure sensor 72b according to the present embodiment detects a temperature and a pressure of a refrigerant flowing out from the interior condenser 12 and flowing into the heating expansion valve 14a.

An outdoor unit side refrigerant temperature and pressure sensor 72c is an outdoor unit side refrigerant temperature and pressure detection part that detects an outdoor unit side refrigerant temperature T2 and an outdoor unit side refrigerant pressure P2 of the refrigerant flowing out from the exterior heat exchanger 16.

A chiller side refrigerant temperature and pressure sensor 72d is a chiller side refrigerant temperature and pressure detection part that detects a chiller side refrigerant temperature Tc and a chiller side refrigerant pressure Pc of the refrigerant flowing out from the refrigerant passage of the chiller 19.

In the present embodiment, a detection part in which a pressure detection part and a temperature detection part are integrated is employed as a refrigerant temperature and pressure sensor, and it is needless to say that a pressure detection part and a temperature detection part implemented separately from each other may be employed.

An evaporator temperature sensor 72f is an evaporator temperature detection part that detects a refrigerant evaporation temperature (evaporator temperature) Tefin in the interior evaporator 18. Specifically, the evaporator temperature sensor 72f according to the present embodiment detects a temperature of the heat exchange fin of the interior evaporator 18.

A heating medium temperature sensor 73 is a heating medium temperature detection part that detects a cooling heating medium temperature TWB, which is the temperature of the heating medium flowing into the coolant passage 80a of the battery 80.

A battery temperature sensor 74 is a battery temperature detection part that detects a battery temperature TB that is a temperature of the battery 80. The battery temperature sensor 74 includes a plurality of temperature sensors and detects temperatures of a plurality of locations of the battery 80. Therefore, the control device 70 can detect a temperature difference and a temperature distribution of each of the battery cells forming the battery 80. Further, as the battery temperature TB, an average value of detection values of the plurality of temperature sensors is employed.

A conditioned air temperature sensor 75 is a conditioned air temperature detection part that detects a blown air temperature TAV, which is a temperature of the blown air blown from the mixing space 56 into the vehicle interior.

A humidity sensor 76 is an inside air humidity detection part that detects an inside air humidity RHr (in the present embodiment, a relative humidity) in the vicinity of a vehicle window glass of the vehicle interior. The inside air humidity RHr is a physical quantity correlated with the ease of fogging of the vehicle window glass. Therefore, the inside air humidity RHr can be used to determine whether defogging of the vehicle window glass is necessary. Therefore, the humidity sensor 76 according to the present embodiment is a window fogging detection part.

Further, as shown in FIG. 3, an operation panel 79 disposed in the vicinity of an instrument panel in a front portion of the vehicle interior is connected to the input side of the control device 70. Operation signals from various operation switches provided on an operation panel 79 are input to the control device 70.

Specific examples of the various operation switches provided on the operation panel 79 include an auto switch, an air conditioner switch, an air volume setting switch, and a temperature setting switch.

The auto switch is an automatic control setting part that sets or cancels an automatic control operation of the vehicle air conditioning device 1. The air conditioner switch is a cooling request part that requests the interior evaporator 18 to cool the blown air. The air volume setting switch is an air volume setting part that manually sets an air blowing amount of the blower 52. The temperature setting switch is a temperature setting part that sets a vehicle interior setting temperature Tset.

The control device 70 according to the present embodiment is integrally implemented with a controller that controls various control target devices connected to the output side thereof. Therefore, a configuration (hardware and software) that controls the operation of each of the control target devices constitutes a controller that controls the operation of each control target device.

For example, a configuration of the control device 70 that controls the rotation speed of the compressor 11 constitutes a dispensing capacity controller 70a. The configuration for controlling the operation of the refrigerant circuit switching valves such as the first on-off valve 15a to the fifth on-off valve 15e constitutes a refrigerant circuit switching controller 70b. The configuration for controlling the operation of the heating medium circuit switching valve such as the low-temperature side heating medium three-way valve 32a constitutes a heating medium circuit switching controller 70c.

The configuration for controlling the actuator for driving the auxiliary outside air door 57 constitutes an auxiliary outside air door controller 70d. The configuration for controlling the actuator for driving the exhaust door 58 constitutes an exhaust door controller 70e.

The configuration of the control device 70 that determines whether the battery 80 needs to be cooled using the cooling capacity of the heat pump cycle 10 constitutes a cooling determination part 70f. The configuration of the control device 70 that determines whether the defogging of the vehicle window glass is necessary constitutes a defogging determination part 70g.

Next, the operation of the vehicle air conditioning device 1 will be described. In the vehicle air conditioning device 1, various operation modes can be switched in order to perform appropriate air conditioning of the vehicle interior and appropriate temperature adjustment of the battery 80. Switching of the operation mode is performed by executing a control program stored in advance in the control device 70.

The control program is executed not only when a start switch (so-called ignition switch) of a vehicle system is turned on and the vehicle system is activated, but also when the battery 80 is charged from an external power supply. The control program performs air conditioning of the vehicle interior when the auto switch is turned on.

The control program reads the detection signals of the control sensors and the operation signals of the operation switches of the operation panel 79. Further, when the auto switch of the operation panel 79 is turned on, the control program calculates a target blowing temperature TAO based on the read detection signal and operation signal. The target blowing temperature TAO is a target temperature of the blown air blown into the vehicle interior.

The target blowing temperature TAO is calculated using the following formula F2.

TAO=Kset×Tset−Kr×Tr−Kam×Tam−Ks×As+C (F2)

Tset is a vehicle interior setting temperature set by the temperature setting switch of the operation panel 79. Tr is the inside air temperature detected by the inside air temperature sensor 71a. Tam is the outside air temperature detected by the outside air temperature sensor 71b. As is the solar radiation amount detected by the solar radiation amount sensor 71c. Kset, Kr, Kam, and Ks are control gains, and C is a constant for correction.

Further, the control program selects the operation mode based on the detection signal, the operation signal, the target blowing temperature TAO, and the like. Further, the operation of the various control target devices is controlled according to the selected operation mode.

In the control program, until a predetermined end condition is satisfied, a control routine such as reading of a detection signal and an operation signal, calculation of the target blowing temperature TAO, selection of an operation mode, and operation control of various control target devices according to the selected operation mode is repeated for each predetermined control cycle. The detailed operation of each operation mode will be described below.

### (a) Cooling Mode

A cooling mode is an operation mode in which the cooled blown air is blown into the vehicle interior to cool the vehicle interior. The cooling mode is likely to be selected when the outside air temperature Tam is relatively high (25° C. or higher in the present embodiment) or when the target blowing temperature TAO is relatively low in a state in which the auto switch and the air conditioner switch are turned on.

The cooling mode includes a single cooling mode and a cool-form cooling mode. The single cooling mode is an operation mode in which the vehicle interior is cooled without cooling the battery 80 using the cooling capacity of the heat pump cycle 10. The cool-form cooling mode is an operation mode in which the cooling capacity of the heat pump cycle 10 is used to cool the battery 80 and cool the vehicle interior.

Here, the cooling determination part 70f according to the present embodiment determines that the battery 80 needs to be cooled using the cooling capacity of the heat pump cycle 10 when the battery temperature TB detected by the battery temperature sensor 74 is equal to or higher than a predetermined reference cooling temperature KTB. The same applies to other operation modes.

(a-1) Single Cooling Mode

In the heat pump cycle 10 in the single cooling mode, the control device 70 brings the heating expansion valve 14a into a fully opened state, brings the cooling expansion valve 14b into a throttle state in which a refrigerant pressure reduction action is exerted, and brings the cooling expansion valve 14c into the fully closed state. The control device 70 opens the first on-off valve 15a, closes the second on-off valve 15b, closes the third on-off valve 15c, closes the fourth on-off valve 15d, and opens the fifth on-off valve 15e.

Therefore, in the heat pump cycle 10 in the single cooling mode, the refrigerant circuit is switched to a refrigerant circuit in which the refrigerant discharged from the compressor 11 circulates in an order of the interior condenser 12, the heating expansion valve 14a in the fully opened state, the exterior heat exchanger 16, the cooling expansion valve 14b, the interior evaporator 18, the evaporation pressure adjustment valve 20, the accumulator 21, and the suction port side of the compressor 11.

The control device 70 controls the refrigerant dispensing capacity of the compressor 11 so that the evaporator temperature Tefin detected by the evaporator temperature sensor 72f approaches a target evaporator temperature TEO. The target evaporator temperature TEO is determined based on the target blowing temperature TAO with reference to a control map stored in advance in the control device 70.

In the control map, the target evaporator temperature TEO is increased as the target blowing temperature TAO increases. In the control map, the target evaporator temperature TEO is determined within a range in which frost formation on the interior evaporator 18 can be reduced.

The control device 70 controls a throttle opening degree of the cooling expansion valve 14b so that a subcool degree SC2 of the refrigerant flowing into the cooling expansion valve 14b approaches a target subcool degree SCO2. The control device 70 detects the subcool degree SC2 based on the outdoor unit side refrigerant temperature T2 and the outdoor unit side refrigerant pressure P2 detected by the outdoor unit side refrigerant temperature and pressure sensor 72c.

The target subcool degree SCO2 is determined based on the discharged refrigerant pressure Pd detected by the discharged refrigerant temperature and pressure sensor 72a with reference to a control map stored in advance in the control device 70. In the control map, the target subcool degree SCO2 is determined such that a coefficient of performance (that is, COP) of the heat pump cycle 10 is a maximum value.

In the low-temperature side heating medium circuit 30a in the single cooling mode, the control device 70 operates the low-temperature side heating medium pump 31a to exhibit a predetermined reference pumping capacity. The control device 70 controls the operation of the low-temperature side heating medium three-way valve 32a so that the cooling heating medium temperature TWB detected by the heating medium temperature sensor 73 approaches the predetermined reference cooling heating medium temperature KTW.

In the interior air conditioning unit 50 in the single cooling mode, the control device 70 controls the blowing capacity of the blower 52 to exhibit a target blowing capacity. The target blowing capacity of the blower 52 is determined based on the target blowing temperature TAO with reference to the control map stored in advance in the control device 70. In the control map, in order to quickly bring the temperature in the vehicle interior close to a setting temperature, the air blowing amount of the blower 52 is increased when a high air conditioning capacity is required, such as during maximum cooling or during maximum heating.

The control device 70 controls the operation of the electric actuator for the air mix door 54 so that the blown air temperature TAV detected by the conditioned air temperature sensor 75 approaches the target blowing temperature TAO.

The control device 70 controls the operation of the inside and outside air switching device 53 based on the operation signal and the target blowing temperature TAO. The control device 70 controls the operation of the electric actuator for a blowing mode door based on the target blowing temperature TAO with reference to the control map stored in advance in the control device 70.

The control device 70 controls the operation of the electric actuator for the auxiliary outside air door 57 to close the outside air bypass passage 55c. The control device 70 controls the operation of the electric actuator for the exhaust door 58 to close the exhaust port 51a. Further, the control device 70 appropriately controls operations of other control target devices.

Therefore, in the heat pump cycle 10 in the single cooling mode, a vapor compression refrigeration cycle is formed in which the interior condenser 12 and the exterior heat exchanger 16 function as condensers and the interior evaporator 18 functions as an evaporator.

In the interior condenser 12, the heat of the refrigerant is dissipated to the blown air. Accordingly, the blown air is heated. In the exterior heat exchanger 16, the heat of the refrigerant is dissipated to the outside air. In the interior evaporator 18, the refrigerant absorbs heat from the blown air and evaporates. Accordingly, the blown air is cooled.

In the low-temperature side heating medium circuit 30a in the single cooling mode, the heating medium pumped from the low-temperature side heating medium pump 31a flows into the heating medium passage of the chiller 19. Since the refrigerant does not flow through the refrigerant passage, the heating medium flowing into the heating medium passage of the chiller 19 flows out from the chiller 19 without changing the temperature.

The heating medium flowing out from the chiller 19 flows into the coolant passage 80a of the battery 80. Accordingly, the battery 80 is cooled. The heating medium flowing out from the coolant passage 80a flows out to one inflow port side of the heating medium three-way joint 33a and the inlet side of the low-temperature side radiator 34a according to an opening degree of the low-temperature side heating medium three-way valve 32a.

The heating medium flowing into the low-temperature side radiator 34a dissipates heat to the outside air. The heating medium flowing out from the low-temperature side radiator 34a flows into the other inflow port of the heating medium three-way joint 33a. The heating medium flowing out from the heating medium three-way joint 33a is sucked into the low-temperature side heating medium pump 31a and pumped toward the heating medium passage of the chiller 19.

In the interior air conditioning unit 50 in the single cooling mode, air introduced via the inside and outside air switching device 53 is sucked into the blower 52 and blown. In the single cooling mode, the auxiliary outside air door 57 closes the outside air bypass passage 55c. Therefore, the total air volume blown from the blower 52 flows into the interior evaporator 18 and is cooled.

The air cooled by the interior evaporator 18 flows into the heating passage 55a and the cold air bypass passage 55b according to the opening degree of the air mix door 54. The air flowing into the heating passage 55a is heated when passing through the interior condenser 12 as the blown air, and flows into the mixing space 56. Since the exhaust door 58 closes the exhaust port 51a, the air flowing into the cold air bypass passage 55b flows into the mixing space 56 as the blown air without being discharged to the outside of the vehicle cabin.

The blown air that is mixed and temperature-adjusted in the mixing space 56 is blown out to an appropriate location in the vehicle interior via the opening hole. Accordingly, the vehicle interior is cooled.

Here, the cooling mode is an operation mode to be selected when the outside air temperature Tam is relatively high. Therefore, when the cooling mode is selected, the window fogging of the vehicle window glass is less likely to occur. Therefore, in the cooling mode, even when the adsorption amount of the adsorbent 18a reaches the saturation amount, the operation mode for desorbing moisture from the adsorbent 18a is not executed. Therefore, in the cooling mode, cooling of the vehicle interior is continuously performed.

(a-2) Cool-Form Cooling Mode

The cool-form cooling mode is selected when it is determined that it is necessary to cool the battery 80 using the cooling capacity of the heat pump cycle 10 during the execution of the single cooling mode.

In the heat pump cycle 10 in the cool-form cooling mode, the control device 70 brings the heating expansion valve 14a into the fully opened state, brings the cooling expansion valve 14b into the throttle state, and brings the cooling expansion valve 14c into the throttle state. The control device 70 opens the first on-off valve 15a, closes the second on-off valve 15b, closes the third on-off valve 15c, closes the fourth on-off valve 15d, and opens the fifth on-off valve 15e.

Therefore, in the heat pump cycle 10 in the cool-form cooling mode, the refrigerant circuit is switched to a refrigerant circuit in which the refrigerant discharged from the compressor 11 circulates in an order of the interior condenser 12, the heating expansion valve 14a in the fully opened state, the exterior heat exchanger 16, the cooling expansion valve 14b, the interior evaporator 18, the evaporation pressure adjustment valve 20, the accumulator 21, and the suction port side of the compressor 11. At the same time, the refrigerant circuit is switched to a refrigerant circuit in which the refrigerant discharged from the compressor 11 circulates in an order of the interior condenser 12, the heating expansion valve 14a in the fully opened state, the exterior heat exchanger 16, the cooling expansion valve 14c, the refrigerant passage of the chiller 19, the accumulator 21, and the suction port side of the compressor 11. That is, in the cool-form cooling mode, the interior evaporator 18 and the chiller 19 are switched to the refrigerant circuit connected in parallel to the refrigerant flow.

Further, the control device 70 controls the throttle opening degree of the cooling expansion valve 14c to be a predetermined throttle opening degree for the cool-form cooling mode. Further, the control device 70 controls the operations of other control target devices in the same manner as in the single cooling mode.

In the low-temperature side heating medium circuit 30a in the cool-form cooling mode, the heating medium pumped from the low-temperature side heating medium pump 31a flows into the heating medium passage of the chiller 19. The heating medium flowing into the heating medium passage of the chiller 19 is cooled by heat absorbed by the refrigerant. The heating medium cooled by the chiller 19 flows into the coolant passage 80a of the battery 80. Accordingly, the battery 80 is cooled. Other operations are the same as those in the single cooling mode.

Therefore, in the cool-form cooling mode, the vehicle interior can be cooled as in the single cooling mode. Further, in the cool-form cooling mode, the battery 80 can be cooled using the cooling capacity of the heat pump cycle 10.

### (b) Series Dehumidifying and Heating Mode

The series dehumidifying and heating mode is an operation mode in which the vehicle interior is dehumidified and heated by reheating the cooled and dehumidified blown air and blowing the blown air into the vehicle interior. The series dehumidifying and heating mode is easily selected when the outside air temperature Tam is in an intermediate temperature range (in the present embodiment, 10° C. or higher and lower than 25° C.) or when the target blowing temperature TAO is in an intermediate temperature range in a state in which the auto switch and the air conditioner switch are turned on.

The series dehumidifying and heating mode includes the single series dehumidifying and heating mode and the cooling series dehumidifying and heating mode. The single series dehumidifying and heating mode is an operation mode in which the vehicle interior is dehumidified and heated without cooling the battery 80 using the cooling capacity of the heat pump cycle 10. The cooling series dehumidifying and heating mode is an operation mode in which the cooling capacity of the heat pump cycle 10 is used to cool the battery 80 and to dehumidify and heat the vehicle interior.

(b-1) Single Series Dehumidifying and Heating Mode

In the heat pump cycle 10 in the single series dehumidifying and heating mode, the control device 70 brings the heating expansion valve 14a into the throttle state, brings the cooling expansion valve 14b into the throttle state, and brings the cooling expansion valve 14c into the fully closed state. The control device 70 opens the first on-off valve 15a, closes the second on-off valve 15b, closes the third on-off valve 15c, closes the fourth on-off valve 15d, and opens the fifth on-off valve 15e.

Therefore, in the heat pump cycle 10 in the single series dehumidifying and heating mode, the refrigerant circuit is switched to a refrigerant circuit in which the refrigerant discharged from the compressor 11 circulates through the interior condenser 12, the heating expansion valve 14a, the exterior heat exchanger 16, the cooling expansion valve 14b, the interior evaporator 18, the evaporation pressure adjustment valve 20, the accumulator 21, and the suction port side of the compressor 11 in this order.

The control device 70 determines the throttle opening degrees of the heating expansion valve 14a and the cooling expansion valve 14b based on the target blowing temperature TAO with reference to the control map stored in advance in the control device 70. In the control map, the throttle opening degree of the heating expansion valve 14a is decreased and the throttle opening degree of the cooling expansion valve 14b is increased as the target blowing temperature TAO increases. Further, the control device 70 controls the operations of other control target devices in the same manner as in the single cooling mode.

Therefore, in the heat pump cycle 10 in the single series dehumidifying and heating mode, a vapor compression refrigeration cycle is implemented in which the interior condenser 12 functions as a condenser and the interior evaporator 18 functions as an evaporator. In the interior condenser 12, the blown air is heated as in the single cooling mode. In the interior evaporator 18, the blown air is cooled as in the single cooling mode.

Further, in the heat pump cycle 10 in the single series dehumidifying and heating mode, when the saturation temperature of the refrigerant in the exterior heat exchanger 16 is higher than the temperature of the air flowing into the exterior heat exchanger 16, the exterior heat exchanger 16 is caused to function as a condenser. When the saturation temperature of the refrigerant in the exterior heat exchanger 16 is lower than the temperature of the air flowing into the exterior heat exchanger 16, the exterior heat exchanger 16 functions as an evaporator.

In the interior air conditioning unit 50 in the single series dehumidifying and heating mode, similarly to the single cooling mode, the total air volume blown from the blower 52 flows into the interior evaporator 18 and is cooled and dehumidified. Then, the blown air that is mixed and temperature-adjusted in the mixing space 56 is blown out to an appropriate location in the vehicle interior via the opening hole. Accordingly, the vehicle interior is dehumidified and heated. Other operations are the same as those in the single cooling mode.

Further, in the heat pump cycle 10 in the single series dehumidifying and heating mode, the throttle opening degree of the heating expansion valve 14a is decreased and the throttle opening degree of the cooling expansion valve 14b is increased as the target blowing temperature TAO increases. Accordingly, the heating capacity of the blown air in the interior condenser 12 can be improved as the target blowing temperature TAO increases without increasing the rotation speed of the compressor 11.

More specifically, when the saturation temperature of the refrigerant in the exterior heat exchanger 16 is higher than the temperature of the air flowing into the exterior heat exchanger 16, a temperature difference obtained by subtracting the temperature of the air flowing into the exterior heat exchanger 16 from the saturation temperature of the refrigerant in the exterior heat exchanger 16 can be reduced as the target blowing temperature TAO increases.

Therefore, as the target blowing temperature TAO increases, an amount of heat dissipation from the refrigerant to heat exchange air in the exterior heat exchanger 16 can be reduced, and the amount of heat dissipation from the refrigerant to a high-temperature side heating medium in the interior condenser 12 can be increased.

When a saturation temperature of the refrigerant in the exterior heat exchanger 16 is lower than a temperature of the air flowing into the exterior heat exchanger 16, a temperature difference obtained by subtracting the saturation temperature of the refrigerant in the exterior heat exchanger 16 from the temperature of the air flowing into the exterior heat exchanger 16 can be increased as the target blowing temperature TAO increases.

Therefore, as the target blowing temperature TAO increases, an amount of heat absorbed by the refrigerant from the heat exchange air in the exterior heat exchanger 16 can be increased, and the amount of heat dissipation from the refrigerant to the heating medium in the interior condenser 12 can be increased.

As a result, in a series dehumidifying and heating mode, a heating capacity of the blown air in the interior condenser 12 can be improved as the target blowing temperature TAO increases without increasing the rotation speed of the compressor 11.

Here, the series dehumidifying and heating mode is an operation mode to be selected when the outside air temperature Tam is in an intermediate temperature range. Therefore, when the series dehumidifying and heating mode is selected, window fogging of the vehicle window glass is less likely to occur. Therefore, in the series dehumidifying and heating mode, even when the adsorption amount of the adsorbent 18a reaches a saturation amount, an operation mode for desorbing moisture from the adsorbent 18a is not executed. Therefore, in the series dehumidifying and heating mode, the dehumidifying and heating of the vehicle interior can be continuously performed.

However, when it is determined that the defogging of the vehicle window glass is necessary during the execution of the series dehumidifying and heating mode, the mode shifts to the heating mode to be described later.

(b-2) Cooling Series Dehumidifying and Heating Mode

A cooling series dehumidifying and heating mode is selected when it is determined that cooling of the battery 80 is necessary during execution of a single series dehumidifying and heating mode.

In the heat pump cycle 10 in the single series dehumidifying and heating mode, the control device 70 brings the heating expansion valve 14a into the throttle state, brings the cooling expansion valve 14b into the throttle state, and brings the cooling expansion valve 14c into the throttle state. The control device 70 opens the first on-off valve 15a, closes the second on-off valve 15b, closes the third on-off valve 15c, closes the fourth on-off valve 15d, and opens the fifth on-off valve 15e.

Therefore, in the heat pump cycle 10 in the single series dehumidifying and heating mode, the refrigerant circuit is switched to a refrigerant circuit in which the refrigerant discharged from the compressor 11 circulates through the interior condenser 12, the heating expansion valve 14a, the exterior heat exchanger 16, the cooling expansion valve 14b, the interior evaporator 18, the evaporation pressure adjustment valve 20, the accumulator 21, and the suction port side of the compressor 11 in this order. At the same time, the refrigerant circuit is switched to a refrigerant circuit in which the refrigerant discharged from the compressor 11 circulates in an order of the interior condenser 12, the heating expansion valve 14a, the exterior heat exchanger 16, the cooling expansion valve 14c, the refrigerant passage of the chiller 19, the accumulator 21, and the suction port side of the compressor 11. That is, in the single series dehumidifying and heating mode, the interior evaporator 18 and the chiller 19 are switched to the refrigerant circuit connected in parallel to the refrigerant flow.

The control device 70 controls the throttle opening degree of the cooling expansion valve 14c to be a predetermined throttle opening degree for the cooling series dehumidifying and heating mode. Further, the control device 70 controls the operations of the other control target devices in the same manner as in the single series dehumidifying and heating mode.

Therefore, in the heat pump cycle 10 in the cooling series dehumidifying and heating mode, a vapor compression refrigeration cycle is implemented in which the interior condenser 12 functions as the condenser and the interior evaporator 18 and the chiller 19 function as the evaporators.

In the interior condenser 12, the blown air is heated as in the single series dehumidifying and heating mode. In the interior evaporator 18, the blown air is cooled as in the single series dehumidifying and heating mode. In the chiller 19, the heating medium is cooled as in the cool-form cooling mode.

Further, in the heat pump cycle 10 in the single series dehumidifying and heating mode, when the saturation temperature of the refrigerant in the exterior heat exchanger 16 is higher than the temperature of the air flowing into the exterior heat exchanger 16, the exterior heat exchanger 16 is caused to function as a condenser. When the saturation temperature of the refrigerant in the exterior heat exchanger 16 is lower than the temperature of the air flowing into the exterior heat exchanger 16, the exterior heat exchanger 16 functions as an evaporator.

In the low-temperature side heating medium circuit 30a in the cooling series dehumidifying and heating mode, the heating medium pumped from the low-temperature side heating medium pump 31a is cooled by the chiller 19 as in the cool-form cooling mode. The heating medium cooled by the chiller 19 flows into the coolant passage 80a of the battery 80. Accordingly, the battery 80 is cooled. Other operations are the same as those in the single series dehumidifying and heating mode.

Therefore, in the cooling series dehumidifying and heating mode, the dehumidifying and heating of the vehicle interior can be performed as in the single series dehumidifying and heating mode. Further, in the cooling series dehumidifying and heating mode, similarly to the cool-form cooling mode, the battery 80 can be cooled using the cooling capacity of the heat pump cycle 10.

### (c) Heating Mode

The heating mode is an operation mode in which the vehicle interior is dehumidified and heated by heating the blown air with a heating capacity higher than that in the series dehumidifying and heating mode and blowing the blown air into the vehicle interior. The heating mode is likely to be selected when the outside air temperature Tam is relatively low (lower than 10° C. in the present embodiment) or when the target blowing temperature TAO is relatively high in a state in which the auto switch and the air conditioner switch are turned on. Further, the heating mode is also selected when it is determined that the defogging of the vehicle window glass is necessary during the execution of the series dehumidifying and heating mode.

Here, the defogging determination part 70g according to the present embodiment determines that the window fogging of the vehicle window glass is detected when the inside air humidity RHr detected by the humidity sensor 76 is equal to or higher than a reference inside air humidity KRHr. That is, it is determined that defogging of the vehicle window glass is necessary. The same applies to other operation modes.

Further, since the heating mode is selected when the outside air temperature Tam is relatively low, the blown air is dehumidified using an adsorption capacity of the adsorbent 18a in order to reduce the window fogging of the vehicle window glass. Therefore, in the heating mode, when the adsorption amount of the adsorbent 18a reaches the saturation amount, it is necessary to desorb the moisture adsorbed by the adsorbent 18a. Therefore, in the heating mode, the desorption heating mode, the inside air adsorption heating mode, and the low-temperature adsorption heating mode are sequentially executed.

The desorption heating mode is an operation mode in which the vehicle interior is heated and the moisture adsorbed by the adsorbent 18a is desorbed.

The inside air adsorption heating mode is an operation mode in which the vehicle interior is heated and moisture contained in the blown air is adsorbed by the adsorbent 18a without causing the refrigerant to flow into the interior evaporator 18. Further, the inside air adsorption heating mode includes a single inside air adsorption heating mode and a cooled inside air adsorption heating mode.

The single inside air adsorption heating mode is an inside air adsorption heating mode in which the battery 80 is not cooled using the cooling capacity of the heat pump cycle 10. The cooled inside air adsorption heating mode is an inside air adsorption heating mode in which the battery 80 is cooled using the cooling capacity of the heat pump cycle 10.

The low-temperature adsorption heating mode is an operation mode in which the vehicle interior is heated, the refrigerant flows into the interior evaporator 18, and the moisture adsorption amount of the adsorbent 18a is increased more than in the inside air adsorption heating mode. Further, the low-temperature adsorption heating mode includes a single low-temperature adsorption heating mode and a cooled low-temperature adsorption heating mode.

The single low-temperature adsorption heating mode is a low-temperature adsorption heating mode in which the battery 80 is not cooled using the cooling capacity of the heat pump cycle 10. The cooled low-temperature adsorption heating mode is a low-temperature adsorption heating mode in which the battery 80 is cooled using the cooling capacity of the heat pump cycle 10.

(c-1) Desorption Heating Mode

The desorption heating mode needs to be selected when or immediately before the adsorption amount of the adsorbent 18a reaches the saturation amount. Therefore, in the present embodiment, when it is determined that the defogging of the vehicle window glass is necessary during the execution of the low-temperature adsorption heating mode, the desorption heating mode is selected. The desorption heating mode is continued until a predetermined reference desorption time elapses.

In the heat pump cycle 10 in the desorption heating mode, the control device 70 brings the heating expansion valve 14a into the throttle state, brings the cooling expansion valve 14b into the throttle state, and brings the cooling expansion valve 14c into the fully closed state. The control device 70 closes the first on-off valve 15a, opens the second on-off valve 15b, opens the third on-off valve 15c, opens the fourth on-off valve 15d, and closes the fifth on-off valve 15e.

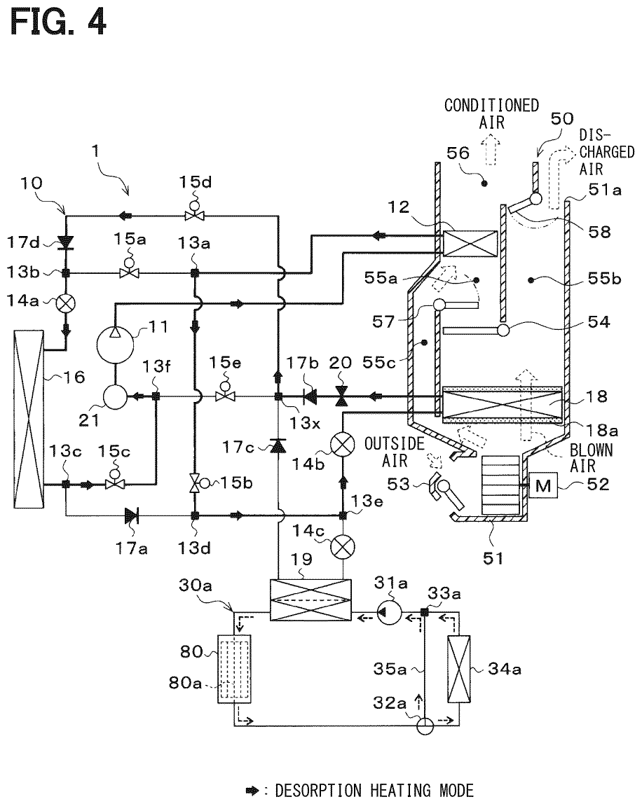

Therefore, in the heat pump cycle 10 in the desorption heating mode, as indicated by black arrows in FIG. 4, the refrigerant circuit is switched to a refrigerant circuit in which the refrigerant discharged from the compressor 11 circulates in an order of the interior condenser 12, the cooling expansion valve 14b, the interior evaporator 18, the evaporation pressure adjustment valve 20, the heating expansion valve 14a, the exterior heat exchanger 16, the accumulator 21, and the suction port side of the compressor 11.

The control device 70 controls the refrigerant dispensing capacity of the compressor 11 so that the discharged refrigerant pressure Pd detected by the discharged refrigerant temperature and pressure sensor 72a approaches a target high pressure PDO. The target high pressure PDO is determined based on the target blowing temperature TAO with reference to the control map stored in advance in the control device 70. In the control map, the target high pressure PDO is determined to increase as the target blowing temperature TAO increases.

The control device 70 controls the throttle opening degree of the cooling expansion valve 14b so that the evaporator temperature Tefin approaches a predetermined reference desorption temperature KTe1 (50° C. in the present embodiment).

The reference desorption temperature KTe1 is determined to be a value higher than the inside air temperature Tr and lower than an endurance temperature of the interior evaporator 18. As the endurance temperature, the saturation temperature of the refrigerant at a maximum allowable pressure determined based on pressure resistance performance of the interior evaporator 18 can be employed. The endurance temperature of the interior evaporator 18 according to the present embodiment is about 60° C.

The control device 70 controls the throttle opening degree of the heating expansion valve 14a so that the subcool degree SC1 of the refrigerant flowing into the heating expansion valve 14a approaches the target subcool degree SCO1. The control device 70 detects the subcool degree SC1 based on the high-pressure side refrigerant temperature T1 and the high-pressure side refrigerant pressure P1 detected by the high-pressure side refrigerant temperature and pressure sensor 72b.

The target subcool degree SCO1 is determined based on the discharged refrigerant pressure Pd with reference to the control map stored in advance in the control device 70. In the control map, the target subcool degree SCO1 is determined such that the COP of the heat pump cycle 10 is the maximum value.

In the interior air conditioning unit 50 in the desorption heating mode, the control device 70 controls the operation of the inside and outside air switching device 53 so that the outside air is introduced into the air conditioning case 51. The control device 70 controls the operation of the electric actuator for the air mix door 54 to fully close the heating passage 55a side and fully open the cold air bypass passage 55b side.

The control device 70 controls the operation of the electric actuator for the auxiliary outside air door 57 to open the outside air bypass passage 55c. The control device 70 controls the operation of the electric actuator for the exhaust door 58 to fully open an exhaust port 51a side and fully close a mixing space 56 side. Further, the control device 70 controls the operations of other control target devices in the same manner as in the single cooling mode.

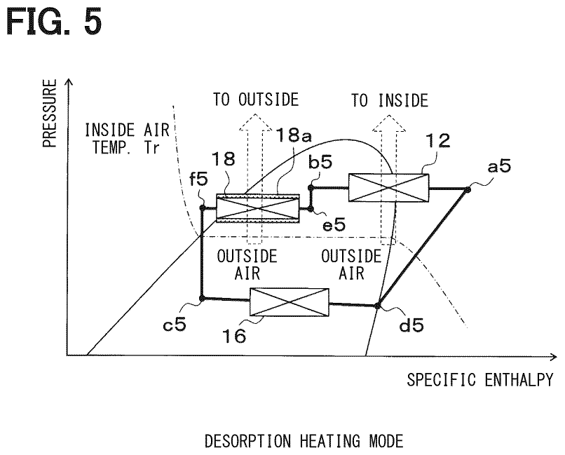

Therefore, in the heat pump cycle 10 in the desorption heating mode, the state of the refrigerant changes as shown in a Mollier diagram of FIG. 5. That is, the refrigerant discharged from the compressor 11 (a point a5 in FIG. 5) flows into the interior condenser 12. The refrigerant flowing into the interior condenser 12 dissipates heat to the outside air introduced through the outside air bypass passage 55c and condenses (from the point a5 to a point b5 in FIG. 5). Accordingly, the outside air as the blown air is heated.

The refrigerant flowing out from the interior condenser 12 flows into the cooling expansion valve 14b and is reduced in pressure (from the point b5 to a point e5 in FIG. 5). At this time, the throttle opening degree of the cooling expansion valve 14b is adjusted so that the evaporator temperature Tefin approaches the reference desorption temperature KTe1. The refrigerant whose pressure is reduced by the cooling expansion valve 14b flows into the interior evaporator 18.

The refrigerant flowing into the interior evaporator 18 dissipates heat to the outside air blown from the blower 52 and the adsorbent 18a and condenses (from the point e5 to a point f5 in FIG. 5). Accordingly, the temperature of the adsorbent 18a increases, and the moisture adsorbed by the adsorbent 18a is desorbed.

The refrigerant flowing out from the interior evaporator 18 flows into the heating expansion valve 14a and is reduced in pressure (from the point f5 to a point c5 in FIG. 5). The refrigerant whose pressure is reduced by the heating expansion valve 14a flows into the exterior heat exchanger 16. The refrigerant flowing into the exterior heat exchanger 16 absorbs heat from the outside air and evaporates (from the point c5 to a point d5 in FIG. 5).

The refrigerant flowing out from the exterior heat exchanger 16 flows into the accumulator 21. A gas-phase refrigerant separated by the accumulator 21 is sucked into the compressor 11 and compressed again (from the point d5 to the point a5 in FIG. 5).

In the interior air conditioning unit 50 in the desorption heating mode, the outside air introduced via the inside and outside air switching device 53 is sucked into the blower 52 and blown. In the desorption heating mode, the auxiliary outside air door 57 opens the outside air bypass passage 55c. Therefore, the outside air blown from the blower 52 flows into both the interior evaporator 18 and the outside air bypass passage 55c.

The outside air flowing into the interior evaporator 18 from the blower 52 is heated by heat exchange with the refrigerant when passing through the interior evaporator 18, and is humidified by moisture desorbed from the adsorbent 18a. In the desorption heating mode, the air mix door 54 fully closes the heating passage 55a side, and the exhaust door 58 fully closes the mixing space 56 side. Therefore, the outside air humidified by the interior evaporator 18 flows into the cold air bypass passage 55b and is discharged to the outside of the vehicle cabin through the exhaust port 51a.

The outside air flowing from the blower 52 into the outside air bypass passage 55c flows into the heating passage 55a as the blown air, and is heated when passing through the interior condenser 12. The blown air heated by the interior condenser 12 flows into the mixing space 56. The blown air flowing into the mixing space 56 is blown out to an appropriate location in the vehicle interior through the opening hole. Accordingly, the vehicle interior is heated. Other operations are the same as those in the single cooling mode.

Therefore, in the desorption heating mode, the vehicle interior can be heated while desorbing the adsorbent 18a. Further, in the desorption heating mode, the refrigerant evaporation temperature in the exterior heat exchanger 16 can be lowered and an amount of heat absorbed by the refrigerant can be increased as compared with the series dehumidifying and heating mode. Therefore, in the desorption heating mode, the heating capacity of the blown air in the interior condenser 12 can be improved more than in the series dehumidifying and heating mode.

In the desorption heating mode, since the outside air having a lower humidity than the inside air is blown into the vehicle interior as the blown air, it is possible to reduce the window fogging of the vehicle window glass without causing the moisture contained in the blown air to be adsorbed by the adsorbent 18a.

(c-2-1) Single Inside Air Adsorption Heating Mode

The single inside air adsorption heating mode is selected when it is not determined that it is necessary to cool the battery 80 using the cooling capacity of the heat pump cycle 10 when the desorption heating mode ends.

In the heat pump cycle 10 in the single inside air adsorption heating mode, the control device 70 brings the heating expansion valve 14a into the throttle state, brings the cooling expansion valve 14b into the fully closed state, and brings the cooling expansion valve 14c into the fully closed state. The control device 70 opens the first on-off valve 15a, closes the second on-off valve 15b, opens the third on-off valve 15c, closes the fourth on-off valve 15d, and closes the fifth on-off valve 15e.

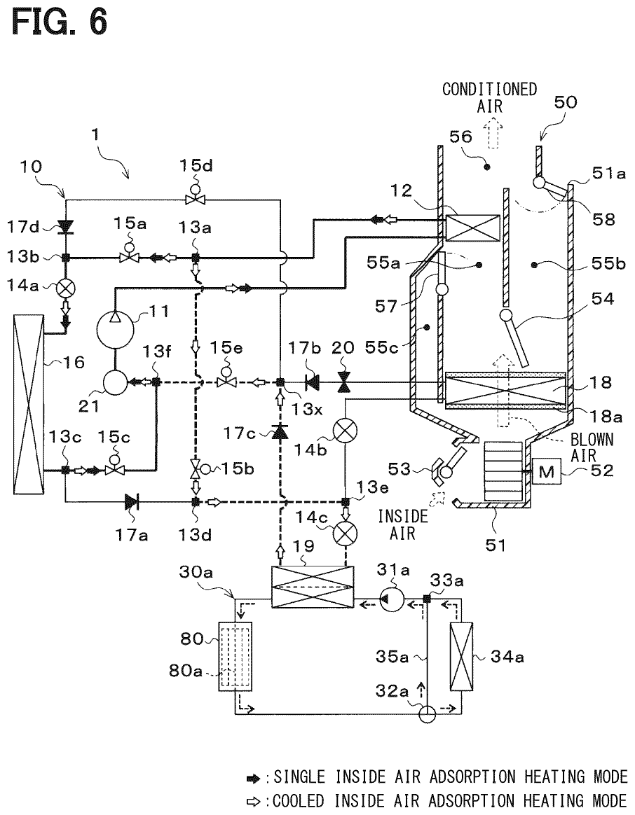

Therefore, in the heat pump cycle 10 in the single inside air adsorption heating mode, as indicated by black arrows in FIG. 6, the refrigerant circuit is switched to a refrigerant circuit in which the refrigerant discharged from the compressor 11 circulates in an order of the interior condenser 12, the heating expansion valve 14a, the exterior heat exchanger 16, the accumulator 21, and the suction port side of the compressor 11. That is, in the single inside air adsorption heating mode, the refrigerant circuit is switched to a refrigerant circuit in which the refrigerant bypasses the interior evaporator 18.

In the interior air conditioning unit 50 in the single inside air adsorption heating mode, the control device 70 controls the operation of the inside and outside air switching device 53 so that the inside air is introduced into the air conditioning case 51. The control device 70 controls the operation of the electric actuator for the air mix door 54 so that the blown air temperature TAV approaches the target blowing temperature TAO.

The control device 70 controls the operation of the electric actuator for the auxiliary outside air door 57 to close the outside air bypass passage 55c. The control device 70 controls the operation of the electric actuator for the exhaust door 58 to close the exhaust port 51a. Further, the control device 70 controls the operations of other control target devices in the same manner as in the desorption heating mode.

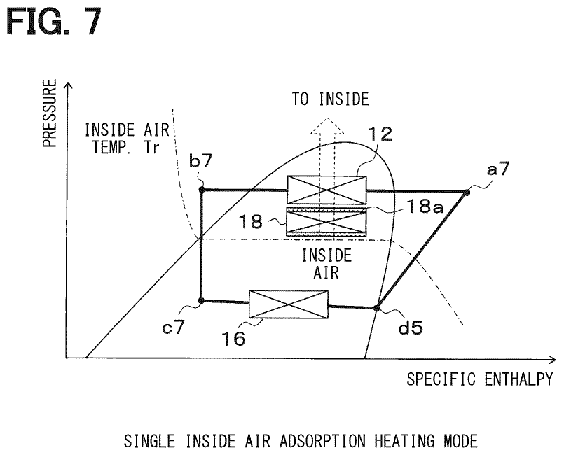

Therefore, in the heat pump cycle 10 in the single inside air adsorption heating mode, the state of the refrigerant changes as shown in the Mollier diagram of FIG. 7. That is, the refrigerant discharged from the compressor 11 (a point a7 in FIG. 7) flows into the interior condenser 12. The refrigerant flowing into the interior condenser 12 dissipates heat to the blown air flowing through the heating passage 55a and condenses (points a7 to b7 in FIG. 7). Accordingly, the blown air is heated.

The refrigerant flowing out from the interior condenser 12 flows into the heating expansion valve 14a and is reduced in pressure (from the point b7 to the point c7 in FIG. 7). The refrigerant whose pressure is reduced by the heating expansion valve 14a flows into the exterior heat exchanger 16. The refrigerant flowing into the exterior heat exchanger 16 absorbs heat from the outside air and evaporates (from the point c7 to the point d7 in FIG. 7).

The refrigerant flowing out from the exterior heat exchanger 16 flows into the accumulator 21. The gas-phase refrigerant separated by the accumulator 21 is sucked into the compressor 11 and compressed again (from the point d7 to the point a7 in FIG. 7).

In the interior air conditioning unit 50 in the single inside air adsorption heating mode, the inside air introduced via the inside and outside air switching device 53 is sucked into the blower 52 and blown. In the single inside air adsorption heating mode, the auxiliary outside air door 57 closes the outside air bypass passage 55c. Therefore, the total air volume of the inside air blown from the blower 52 flows into the interior evaporator 18.

In the single inside air adsorption heating mode, the refrigerant is not allowed to flow into the interior evaporator 18. Therefore, when the inside air flowing into the interior evaporator 18 passes through the interior evaporator 18, the temperature of the interior evaporator 18 that becomes relatively high in the desorption heating mode is lowered from a surface layer portion (that is, the outer surface) side. Accordingly, the moisture contained in the inside air is adsorbed by the adsorbent 18a of the interior evaporator 18, and the inside air is dehumidified.

The inside air dehumidified by the adsorbent 18a of the interior evaporator 18 flows into the heating passage 55a and the cold air bypass passage 55b according to the opening degree of the air mix door 54. The air flowing into the heating passage 55a is heated when passing through the interior condenser 12 as the blown air, and flows into the mixing space 56. Since the exhaust door 58 closes the exhaust port 51a, the air flowing into the cold air bypass passage 55b flows into the mixing space 56 as the blown air.

The blown air that is mixed and temperature-adjusted in the mixing space 56 is blown out to an appropriate location in the vehicle interior via the opening hole. Accordingly, the vehicle interior is dehumidified and heated. Other operations are the same as those in the desorption heating mode.

Further, in the inside air adsorption heating mode, similarly to the desorption heating mode, the refrigerant evaporation temperature in the exterior heat exchanger 16 can be lowered and the amount of heat absorbed by the refrigerant can be increased as compared with the series dehumidifying and heating mode. Therefore, in the inside air adsorption heating mode, the heating capacity of the blown air in the interior condenser 12 can be improved more than in the series dehumidifying and heating mode.

In the inside air adsorption heating mode, inside air having a higher temperature than the outside air is introduced as the blown air. Therefore, it is possible to reduce the energy consumed to heat the blown air to a desired temperature in the interior condenser 12 as compared with the case in which the outside air is introduced. Further, in the inside air adsorption heating mode, since the moisture contained in the blown air can be adsorbed by the adsorbent 18a, fogging of the vehicle window glass can be reduced.

(c-2-2) Cooled Inside Air Adsorption Heating Mode

The cooled inside air adsorption heating mode is selected when it is determined that it is necessary to cool the battery 80 using the cooling capacity of the heat pump cycle 10 when the desorption heating mode ends.

In the heat pump cycle 10 in the cooled inside air adsorption heating mode, the control device 70 brings the heating expansion valve 14a into the throttle state, brings the cooling expansion valve 14b into the fully closed state, and brings the cooling expansion valve 14c into the throttle state. The control device 70 opens the first on-off valve 15a, opens the second on-off valve 15b, opens the third on-off valve 15c, closes the fourth on-off valve 15d, and opens the fifth on-off valve 15e.

Therefore, in the heat pump cycle 10 in the cooled inside air adsorption heating mode, as indicated by white arrows in FIG. 6, the refrigerant circuit is switched to a refrigerant circuit in which the refrigerant discharged from the compressor 11 circulates in an order of the interior condenser 12, the heating expansion valve 14a, the exterior heat exchanger 16, the accumulator 21, and the suction port side of the compressor 11. At the same time, the refrigerant circuit is switched to a refrigerant circuit in which the refrigerant discharged from the compressor 11 circulates in an order of the interior condenser 12, the cooling expansion valve 14c, the refrigerant passage of the chiller 19, and the suction port side of the compressor 11. That is, in the cooled inside air adsorption heating mode, the refrigerant is caused to flow while bypassing the interior evaporator 18, and the exterior heat exchanger 16 and the chiller 19 are switched to the refrigerant circuit connected in parallel to the refrigerant flow.

The control device 70 controls the throttle opening degree of the cooling expansion valve 14c to be a predetermined throttle opening degree for the cooled inside air adsorption heating mode. Further, the control device 70 controls the operations of the other control target devices in the same manner as in the single inside air adsorption heating mode.

Therefore, in the heat pump cycle 10 in the cooled inside air adsorption heating mode, a vapor compression refrigeration cycle is implemented in which the interior condenser 12 functions as the condenser and the exterior heat exchanger 16 and the chiller 19 function as the evaporators.

In the interior condenser 12, the blown air is heated as in the single inside air adsorption heating mode. In the chiller 19, the heating medium is cooled as in the cool-form cooling mode.

In the low-temperature side heating medium circuit 30a in the cooled inside air adsorption heating mode, the heating medium flows into the coolant passage 80a of the battery 80 as in the cool-form cooling mode. Accordingly, the battery 80 is cooled. Other operations are the same as those in the single inside air adsorption heating mode.

Therefore, in the cooled inside air adsorption heating mode, the vehicle interior can be dehumidified and heated as in the single inside air adsorption heating mode. Further, in the cooled inside air adsorption heating mode, similarly to the cool-form cooling mode, the battery 80 can be cooled using the cooling capacity of the heat pump cycle 10.

(c-3-1) Single Low-Temperature Adsorption Heating Mode

A single low-temperature adsorption heating mode is selected when it is determined that the defogging of the vehicle window glass is necessary during the execution of a single inside air adsorption heating mode.

In the heat pump cycle 10 in the single low-temperature adsorption heating mode, the control device 70 brings the heating expansion valve 14a into the throttle state, brings the cooling expansion valve 14b into the throttle state, and brings the cooling expansion valve 14c into the fully closed state. The control device 70 opens the first on-off valve 15a, opens the second on-off valve 15b, opens the third on-off valve 15c, closes the fourth on-off valve 15d, and closes the fifth on-off valve 15e.

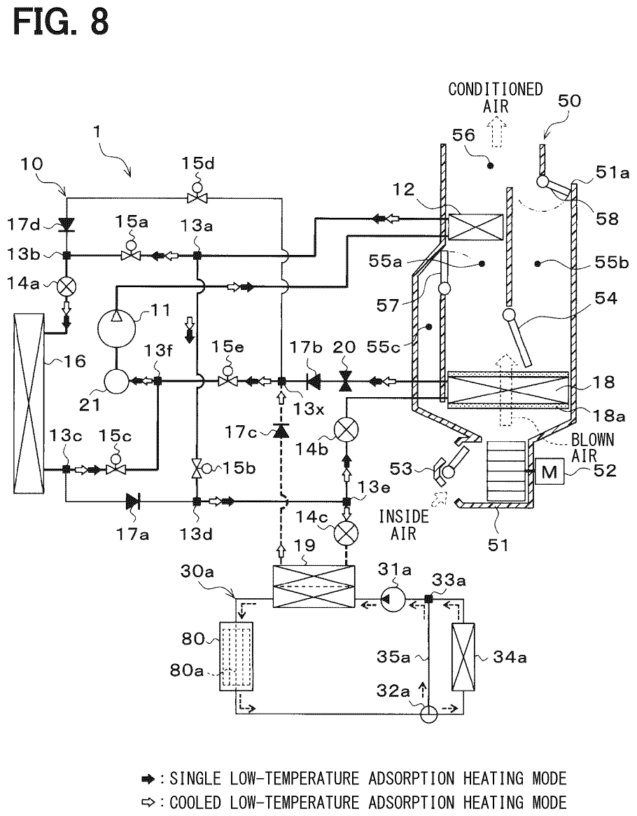

Therefore, in the heat pump cycle 10 in the single low-temperature adsorption heating mode, as indicated by black arrows in FIG. 8, the refrigerant circuit is switched to a refrigerant circuit in which the refrigerant discharged from the compressor 11 circulates in an order of the interior condenser 12, the heating expansion valve 14a, the exterior heat exchanger 16, the accumulator 21, and the suction port side of the compressor 11. At the same time, the refrigerant circuit is switched to a refrigerant circuit in which the refrigerant discharged from the compressor 11 circulates in an order of the interior condenser 12, the cooling expansion valve 14b, the interior evaporator 18, the evaporation pressure adjustment valve 20, the accumulator 21, and the suction port side of the compressor 11. That is, the exterior heat exchanger 16 and the interior evaporator 18 are switched to the refrigerant circuit connected in parallel to the refrigerant flow.

The control device 70 controls the throttle opening degree of the cooling expansion valve 14b so that the evaporator temperature Tefin approaches the inside air temperature Tr. Further, the control device 70 controls the operations of the other control target devices in the same manner as in the single inside air adsorption heating mode.

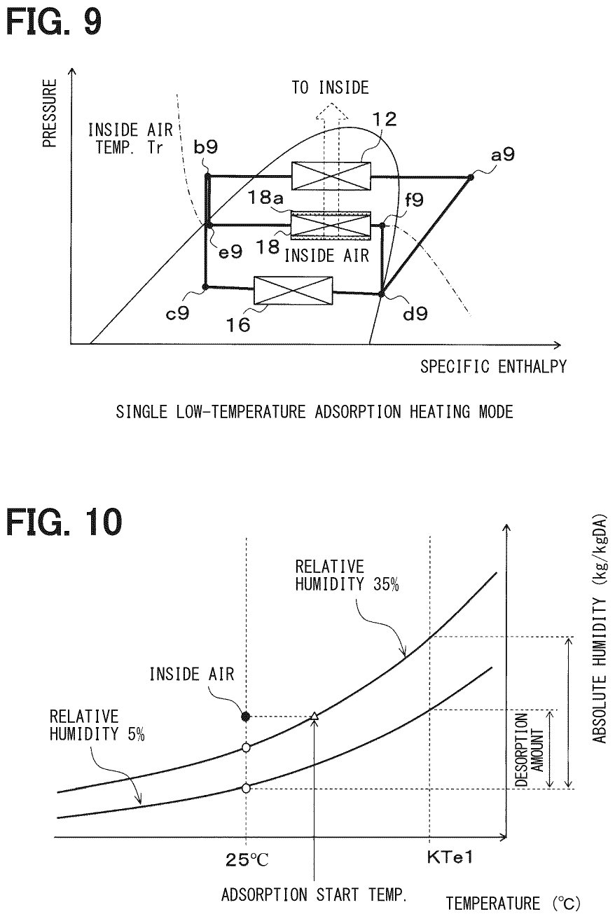

Therefore, in the heat pump cycle 10 in the single low-temperature adsorption heating mode, the state of the refrigerant changes as shown in the Mollier diagram of FIG. 9. That is, the refrigerant discharged from the compressor 11 (a point a9 in FIG. 9) flows into the interior condenser 12. The refrigerant flowing into the interior condenser 12 dissipates heat to the blown air flowing through the heating passage 55a and condenses (points a9 to b9 in FIG. 9). Accordingly, the blown air is heated.

The flow of the refrigerant flowing out from the interior condenser 12 is branched by the first three-way joint 13a. One refrigerant branched by the first three-way joint 13a flows into the heating expansion valve 14a and is reduced in pressure (from the point b9 to a point c9 in FIG. 9). The refrigerant whose pressure is reduced by the heating expansion valve 14a flows into the exterior heat exchanger 16. The refrigerant flowing into the exterior heat exchanger 16 absorbs heat from the outside air and evaporates (from the point c9 to a point d9 in FIG. 9).

The other refrigerant branched by the first three-way joint 13a flows into the cooling expansion valve 14b and is reduced in pressure (from the point b9 to a point e9 in FIG. 9). The refrigerant whose pressure is reduced by the cooling expansion valve 14b flows into the interior evaporator 18. The refrigerant flowing into the interior evaporator 18 absorbs heat from the interior evaporator 18 and the inside air to evaporate (from the point e9 to a point f9 in FIG. 9). The refrigerant flowing out from the interior evaporator 18 is reduced in pressure by the evaporation pressure adjustment valve 20 (from the point f9 to the point d9 in FIG. 9).

The flow of the refrigerant flowing out from the exterior heat exchanger 16 and the flow of the refrigerant flowing out from the evaporation pressure adjustment valve 20 merge at the sixth three-way joint 13f. The refrigerant flowing out from the sixth three-way joint 13f flows into the accumulator 21. The gas-phase refrigerant separated by the accumulator 21 is sucked into the compressor 11 and compressed again (from the point d9 to the point a9 in FIG. 9). Other operations are the same as those in the single inside air adsorption heating mode.

Therefore, in the single low-temperature adsorption heating mode, the vehicle interior can be dehumidified and heated as in the single inside air adsorption heating mode.

Further, in the low-temperature adsorption heating mode, similarly to the desorption heating mode, the refrigerant evaporation temperature in the exterior heat exchanger 16 can be lowered and the amount of heat absorbed by the refrigerant can be increased as compared with the series dehumidifying and heating mode. Therefore, in the low-temperature adsorption heating mode, the heating capacity of the blown air in the interior condenser 12 can be improved more than in the series dehumidifying and heating mode.

In the low-temperature adsorption heating mode, the inside air having a higher temperature than the outside air is introduced as the blown air. Therefore, similarly to the inside air adsorption heating mode, it is possible to reduce the energy consumed to heat the blown air to a desired temperature in the interior condenser 12.

In addition, in the low-temperature adsorption heating mode, since the refrigerant flows into the interior evaporator 18, a temperature of not only the surface layer portion side of the adsorbent 18a but also a deep layer portion (that is, a portion closer to the interior evaporator 18 than the outer surface) side can approach the inside air temperature Tr. Therefore, in the low-temperature adsorption heating mode, a moisture adsorption amount of the adsorbent 18a can be increased more than in the inside air adsorption heating mode. As a result, in the low-temperature adsorption heating mode, fogging of the vehicle window glass can be reduced.

(c-3-2) Cooled Low-Temperature Adsorption Heating Mode

The cooled low-temperature adsorption heating mode is selected when it is determined that the defogging of the vehicle window glass is necessary during the execution of a cooled inside air adsorption heating mode.

In the heat pump cycle 10 in the cooled low-temperature adsorption heating mode, the control device 70 brings the heating expansion valve 14a into the throttle state, brings the cooling expansion valve 14b into the throttle state, and brings the cooling expansion valve 14c into the throttle state. The control device 70 opens the first on-off valve 15a, opens the second on-off valve 15b, opens the third on-off valve 15c, closes the fourth on-off valve 15d, and opens the fifth on-off valve 15e.

Therefore, in the heat pump cycle 10 in the single low-temperature adsorption heating mode, as indicated by white arrows in FIG. 8, the refrigerant circuit is switched to a refrigerant circuit in which the refrigerant discharged from the compressor 11 circulates in an order of the interior condenser 12, the heating expansion valve 14a, the exterior heat exchanger 16, the accumulator 21, and the suction port side of the compressor 11. At the same time, the refrigerant circuit is switched to a refrigerant circuit in which the refrigerant discharged from the compressor 11 circulates in an order of the interior condenser 12, the cooling expansion valve 14b, the interior evaporator 18, the evaporation pressure adjustment valve 20, the accumulator 21, and the suction port side of the compressor 11. At the same time, the refrigerant circuit is switched to a refrigerant circuit in which the refrigerant discharged from the compressor 11 circulates in an order of the interior condenser 12, the cooling expansion valve 14c, the refrigerant passage of the chiller 19, the accumulator 21, and the suction port side of the compressor 11. That is, the exterior heat exchanger 16, the interior evaporator 18, and the chiller 19 are switched to the refrigerant circuit connected in parallel to the refrigerant flow.

The control device 70 controls the throttle opening degree of the cooling expansion valve 14c to be a predetermined throttle opening degree for the cooled low-temperature adsorption heating mode. Further, the control device 70 controls the operations of the other control target devices in the same manner as in the single low-temperature adsorption heating mode.

Therefore, in the heat pump cycle 10 in the cooled low-temperature adsorption heating mode, a vapor compression refrigeration cycle is implemented in which the interior condenser 12 functions as the condenser and the exterior heat exchanger 16, the interior evaporator 18, and the chiller 19 function as the evaporators.

In the interior condenser 12, the blown air is heated as in the single low-temperature adsorption heating mode. In the interior evaporator 18, the interior evaporator 18 and the inside air are cooled as in the single low-temperature adsorption heating mode. In the chiller 19, the heating medium is cooled as in the cool-form cooling mode.

In the low-temperature side heating medium circuit 30a in the cooled low-temperature adsorption heating mode, the heating medium flows into the coolant passage 80a of the battery 80 as in the cool-form cooling mode. Accordingly, the battery 80 is cooled. Other operations are the same as those in the single low-temperature adsorption heating mode.

Therefore, in the cooled low-temperature adsorption heating mode, the vehicle interior can be dehumidified and heated as in the single low-temperature adsorption heating mode. Further, in the cooled low-temperature adsorption heating mode, similarly to the cool-form cooling mode, the battery 80 can be cooled using the cooling capacity of the heat pump cycle 10.

As described above, according to the vehicle air conditioning device 1 in the present embodiment, by switching the operation mode, it is possible to achieve comfortable air conditioning in the vehicle interior and appropriate temperature adjustment of the battery 80 which is an in-vehicle device.

Further, in the heating mode of the vehicle air conditioning device 1 in the present embodiment, the inside air having a higher temperature than the outside air is introduced as the blown air in the inside air adsorption heating mode and the low-temperature adsorption heating mode. Therefore, it is possible to reduce the energy consumed to heat the blown air to a desired temperature in the interior condenser 12 which is the heater as compared with the case in which the outside air is introduced as the blown air.

In addition, in the heating mode of the vehicle air conditioning device 1 in the present embodiment, since the inside air adsorption heating mode is executed, the energy consumed for dehumidifying the blown air can be sufficiently reduced.

More specifically, in the inside air adsorption heating mode, the refrigerant circuit of the heat pump cycle 10 is switched to a refrigerant circuit in which the refrigerant bypasses the interior evaporator 18 and flows. That is, the refrigerant circuit of the heat pump cycle 10 is switched to the refrigerant circuit in which the refrigerant does not flow into the interior evaporator 18. Therefore, unnecessary energy is not consumed to cause the refrigerant to flow into the interior evaporator 18.

As a result, according to the vehicle air conditioning device 1 in the present embodiment, it is possible to sufficiently obtain the effect of reducing the energy consumption by providing the interior evaporator 18 having the adsorbent 18a. That is, it is possible to sufficiently reduce the energy consumed when heating the vehicle interior while dehumidifying the blown air.

In the vehicle air conditioning device 1 in the present embodiment, when it is determined that defogging of the vehicle window glass is necessary during the execution of the inside air adsorption heating mode, the mode is switched to the low-temperature adsorption heating mode. In the low-temperature adsorption heating mode, the throttle opening degree of the cooling expansion valve 14b is controlled such that the evaporator temperature Tefin approaches the inside air temperature Tr. Accordingly, the temperature of the deep layer portion of the adsorbent 18a can be brought close to the inside air temperature Tr.

Therefore, in the low-temperature adsorption heating mode, a moisture adsorption amount of the adsorbent 18a can be increased more than in the inside air adsorption heating mode. Further, in the low-temperature adsorption heating mode, since the temperature of the refrigerant flowing into the interior evaporator 18 is not unnecessarily lowered, the dehumidifying and heating of the vehicle interior can be continued while reducing an increase in energy to be consumed for dehumidifying the blown air.

Further, in the vehicle air conditioning device 1 in the present embodiment, since the humidity sensor 76 serving as a window fogging detection part is provided, the desorption heating mode, the inside air adsorption heating mode, and the low-temperature adsorption heating mode can be appropriately switched so that the window fogging of the vehicle window glass can be reduced.

Further, in the vehicle air conditioning device 1 in the present embodiment, the adsorbent 18a that satisfies the above-described formula F1 is employed as the adsorber. Accordingly, when the mode is shifted to the inside air adsorption heating mode, the moisture can be quickly adsorbed by the adsorbent 18a. Further, in the desorption heating mode, the moisture adsorbed by the adsorbent 18a can be sufficiently desorbed.

More specifically, the inside air adsorption heating mode is executed immediately after the desorption heating mode. Therefore, the temperatures of the interior evaporator 18 and the adsorbent 18a immediately after the start of the inside air adsorption heating mode are close to the reference desorption temperature KTe1 (50° C. in the present embodiment). Therefore, it is desirable that the adsorbent 18a can start adsorption of moisture contained in the blown air even when the temperature is relatively high. That is, it is desirable that an adsorption start temperature of the adsorbent 18a is relatively high.

On the other hand, in the present embodiment, the adsorbent 18a in which the maximum relative pressure ratio Rmax is 0.35 or less is employed based on general temperature and humidity (specifically, about 25° C. and relative humidity 38%) of the inside air flowing into the interior evaporator 18 in the inside air adsorption heating mode.

Accordingly, as indicated by a line of the relative humidity 35% in FIG. 10 corresponding to a case in which the maximum relative pressure ratio Rmax is 0.35, the adsorption start temperature can also be set to a relatively high temperature. Therefore, even when the temperature of the adsorbent 18a is relatively high, the moisture contained in the blown air can be adsorbed by the adsorbent 18a.

As described with reference to FIG. 2, in the adsorbent 18a, the adsorption speed (kg/s) tends to increase as the maximum relative pressure ratio Rmax decreases. That is, when the adsorbent 18a having a small maximum relative pressure ratio Rmax is employed, the blown air is easily dehumidified, and a time during which the window fogging of the vehicle window glass can be reduced becomes long.

Therefore, in order to quickly dehumidify the blown air in the inside air adsorption heating mode, it is desirable to employ the adsorbent 18a having a small value of the maximum relative pressure ratio Rmax. However, in the adsorbent 18a having a small value of the maximum relative pressure ratio Rmax, even when the temperature of the adsorbent 18a is increased to the reference desorption temperature KTe1, the adsorbent 18a may not be sufficiently desorbed.

In contrast, in the present embodiment, the adsorbent 18a having the maximum relative pressure ratio Rmax of 0.05 or more is employed based on the general temperature and humidity of the inside air flowing into the interior evaporator 18 in the inside air adsorption heating mode.

Accordingly, a sufficient desorption amount can be secured by increasing the temperature of the adsorbent 18a to the reference desorption temperature KTe1 as indicated by the line of relative humidity of 5% in FIG. 10 corresponding to the case in which the maximum relative pressure ratio Rmax is 0.05. That is, the moisture adsorbed by the adsorbent 18a can be sufficiently desorbed.

### Second Embodiment

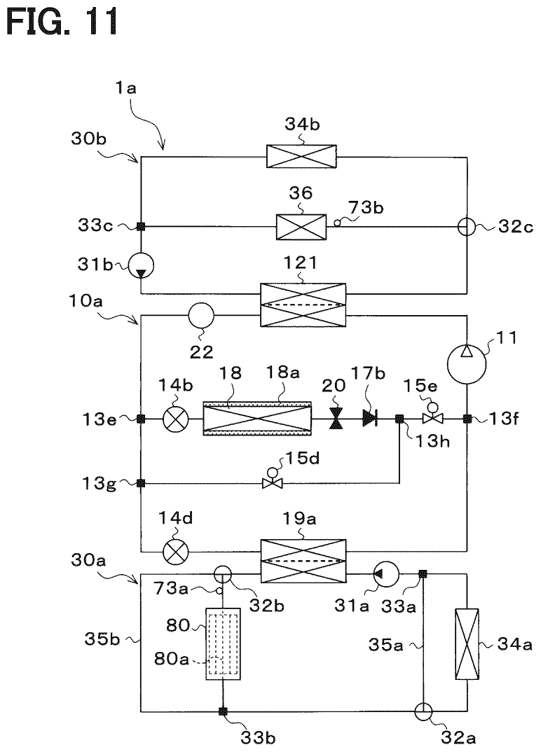

In the present embodiment, a vehicle air conditioning device 1a shown in an overall configuration diagram of FIG. 11 will be described. The vehicle air conditioning device 1a includes a heat pump cycle 10a, a low-temperature side heating medium circuit 30a, a high-temperature side heating medium circuit 30b, the interior air conditioning unit 50, and the like. In FIG. 11, the interior air conditioning unit 50 is omitted for clarity of illustration.

In the heat pump cycle 10a, the interior condenser 12, the heating expansion valve 14a, the first on-off valve 15a to the third on-off valve 15c, the exterior heat exchanger 16, the accumulator 21, and the like are eliminated from the heat pump cycle 10 described in the first embodiment.

Therefore, in the heat pump cycle 10a, an inlet side of the refrigerant passage of a water-refrigerant heat exchanger 121 is connected to a dispensing port of the compressor 11. The water-refrigerant heat exchanger 121 includes a refrigerant passage through which the refrigerant discharged from the compressor 11 flows, and a heating medium passage through which a high-temperature side heating medium circulating through the high-temperature side heating medium circuit 30b flows.

The water-refrigerant heat exchanger 121 is a high-temperature side heating medium heat exchanger that exchanges heat between a high-pressure refrigerant flowing through the refrigerant passage and the high-temperature side heating medium flowing through the heating medium passage. In the water-refrigerant heat exchanger 121, the high-temperature side heating medium is heated by dissipating the heat of the high-pressure refrigerant to the high-temperature side heating medium.

The inlet side of a receiver 22 is connected to the outlet of the refrigerant passage of the water-refrigerant heat exchanger 121. The receiver 22 is a high-pressure side gas-liquid separator that separates gas and liquid of the high-pressure refrigerant flowing out from the refrigerant passage of the water-refrigerant heat exchanger 121 and stores the separated liquid phase refrigerant as a surplus refrigerant in the cycle.

The inflow port side of the fifth three-way joint 13e is connected to the liquid phase refrigerant outlet of the receiver 22. As in the first embodiment, the inlet side of the cooling expansion valve 14b is connected to one outflow port of the fifth three-way joint 13e. One inflow port side of a seventh three-way joint 13g is connected to the other outflow port of the fifth three-way joint 13e.

The inflow port side of an eighth three-way joint 13h is connected to an outlet side of the second check valve 17b in the present embodiment. Therefore, the second check valve 17b in the present embodiment allows the refrigerant to flow to the interior evaporator 18 side or the eighth three-way joint 13h side, and prohibits the refrigerant from flowing from the eighth three-way joint 13h side to the interior evaporator 18 side.

One inflow port side of the sixth three-way joint 13f is connected to one outflow port of the eighth three-way joint 13h via the fifth on-off valve 15e. The other inflow port side of the seventh three-way joint 13g is connected to the other outflow port of the eighth three-way joint 13h via the fourth on-off valve 15d.

An outflow port of the seventh three-way joint 13g is connected to an inlet side of the cooling expansion valve 14d. The inlet side of the refrigerant passage of the chiller 19a is connected to the outlet of the cooling expansion valve 14d. The other inflow port side of the sixth three-way joint 13f is connected to the outlet of the refrigerant passage of the chiller 19a. The cooling expansion valve 14d and the chiller 19a in the present embodiment have the same configurations as the cooling expansion valve 14c and the chiller 19 described in the first embodiment.

Therefore, in the present embodiment, the refrigerant flow path from the other outflow port of the fifth three-way joint 13e to the one inflow port of the seventh three-way joint 13g serves as a refrigerant bypass passage that guides the refrigerant flowing out from the receiver 22 to the suction port side of the compressor 11 while bypassing the interior evaporator 18 in the inside air adsorption heating mode. Other configurations of the heat pump cycle 10a are the same as those of the heat pump cycle 10 described in the first embodiment.

Next, the low-temperature side heating medium circuit 30a will be described. The low-temperature side heating medium circuit 30a in the present embodiment includes the first low-temperature side heating medium three-way valve 32a and a second low-temperature side heating medium three-way valve 32b. The first low-temperature side heating medium three-way valve 32a has the same configuration as the low-temperature side heating medium three-way valve 32a described in the second embodiment. The basic configuration of the second low-temperature side heating medium three-way valve 32b is the same as that of the first low-temperature side heating medium three-way valve 32a.

In the low-temperature side heating medium circuit 30a in the present embodiment, the inflow port side of the second low-temperature side heating medium three-way valve 32b is connected to the outlet of the heating medium passage of the chiller 19a. The inlet side of the coolant passage 80a of the battery 80 is connected to one outflow port of the second low-temperature side heating medium three-way valve 32b. One inflow port side of a second heating medium three-way joint 33b is connected to an outlet of the coolant passage 80a of the battery 80.

The other inflow port side of the second heating medium three-way joint 33b is connected to the other outflow port of the second low-temperature side heating medium three-way valve 32b via a battery bypass passage 35b. An inflow port of the first low-temperature side heating medium three-way valve 32a is connected to an outflow port of the second heating medium three-way joint 33b. Other configurations are the same as those of the low-temperature side heating medium circuit 30a in the first embodiment.

In the low-temperature side heating medium circuit 30a, the chiller 19a can exchange heat between the low-pressure refrigerant whose pressure is reduced by the cooling expansion valve 14d and the heating medium. Further, the low-temperature side radiator 34a exchanges heat between the heating medium and the outside air. That is, in the chiller 19a, heat can be indirectly exchanged between the refrigerant and the outside air via the heating medium.

Therefore, the chiller 19a of the heat pump cycle 10a serves as a refrigerant-outside air heat exchanger. Further, the cooling expansion valve 14d serves as an outside air side pressure reducer that reduces a pressure of the refrigerant flowing into the refrigerant passage of the chiller 19 that is the refrigerant-outside air heat exchanger.

Next, the high-temperature side heating medium circuit 30b will be described. The high-temperature side heating medium circuit 30b is a circuit that circulates the heating medium. In the high-temperature side heating medium circuit 30b, the same type of fluid as in the low-temperature side heating medium circuit 30a is circulated as the heating medium. In the high-temperature side heating medium circuit 30b, a high-temperature side heating medium pump 31b, a heating medium passage of the water-refrigerant heat exchanger 121, a high-temperature side heating medium three-way valve 32c, a heater core 36, a high-temperature side radiator 34b, and the like are disposed.

The high-temperature side heating medium pump 31b is a heating medium pumping part that pumps the high-temperature side heating medium flowing out from a third heating medium three-way joint 33c to the heating medium passage of the water-refrigerant heat exchanger 121. The basic configuration of the high-temperature side heating medium pump 31b is similar to that of the low-temperature side heating medium pump 31a.

The inflow port side of the high-temperature side heating medium three-way valve 32c is connected to the outlet of the heating medium passage of the water-refrigerant heat exchanger 121. The basic configuration of the high-temperature side heating medium three-way valve 32c is similar to that of the first low-temperature side heating medium three-way valve 32a. A heating medium inlet side of the heater core 36 is connected to one outflow port of the high-temperature side heating medium three-way valve 32c. A heating medium inlet side of the high-temperature side radiator 34b is connected to the other outflow port of the high-temperature side heating medium three-way valve 32c.

Similarly to the interior condenser 12 described in the first embodiment, the heater core 36 is disposed in the air conditioning case 51 of the interior air conditioning unit 50. The heater core 36 is a high-temperature side air heat exchanger that exchanges heat between the heating medium flowing out from the water-refrigerant heat exchanger 121 and the blown air passing through the interior evaporator 18. In the heater core 36, the heat of the heating medium flowing out from the water-refrigerant heat exchanger 121 is dissipated to the blown air to heat the blown air. One inflow port side of the third heating medium three-way joint 33c is connected to a heating medium outlet of the heater core 36.

The high-temperature side radiator 34b is a high-temperature side heating medium-outside air heat exchanger that exchanges heat between the heating medium flowing out from the high-temperature side heating medium three-way valve 32c and the outside air blown by an outside air fan (not shown). The high-temperature side radiator 34b is disposed on the front side in the drive device chamber. Therefore, when the vehicle is traveling, a traveling wind can be applied to the low-temperature side radiator 34a. The high-temperature side radiator 34b may be formed integrally with the low-temperature side radiator 34a and the exterior heat exchanger 16.

The other inflow port side of the third heating medium three-way joint 33c is connected to the heating medium outlet of the high-temperature side radiator 34b. The suction port side of the high-temperature side heating medium pump 31b is connected to the outflow port of the third heating medium three-way joint 33c.

In the high-temperature side heating medium circuit 30b, the high-temperature side heating medium can be heated by exchanging heat between the refrigerant discharged from the compressor 11 and the high-temperature side heating medium in the water-refrigerant heat exchanger 121. Further, the heater core 36 can heat the blown air by exchanging heat between the high-temperature side heating medium heated by the water-refrigerant heat exchanger 121 and the blown air.

Therefore, each component disposed in the water-refrigerant heat exchanger 121 and the high-temperature side heating medium circuit 30b in the present embodiment is a heater that heats the blown air using the refrigerant discharged from the compressor 11 as a heat source.

Next, an electric controller of the vehicle air conditioning device 1a will be described. In the present embodiment, a low-temperature side heating medium temperature sensor 73a and a high-temperature side heating medium temperature sensor 73b are added as control sensors connected to the control device 70.

The low-temperature side heating medium temperature sensor 73a is a low-temperature side heating medium temperature detection part that detects a low-temperature side heating medium temperature TWL, which is the temperature of a low-temperature side heating medium flowing into the coolant passage 80a of the battery 80. The high-temperature side heating medium temperature sensor 73b is a high-temperature side heating medium temperature detection part that detects a high-temperature side heating medium temperature TWH which is a temperature of the high-temperature side heating medium flowing into the heater core 36. Other configurations are the same as those of the vehicle air conditioning device 1 in the first embodiment.

Next, the operation of the vehicle air conditioning device 1a according to the present embodiment will be described. In the vehicle air conditioning device 1a, various operation modes can be switched. Specifically, the vehicle air conditioning device 1a can switch between a cooling mode and a heating mode.

Further, in the control program according to the present embodiment, the single cooling mode and the cool-form cooling mode are selected as the cooling mode under the same conditions as in the first embodiment. As the heating mode, a desorption heating mode, an inside air adsorption heating mode, and a low-temperature adsorption heating mode are selected. Hereinafter, each operation mode will be described.

(a-1) Single Cooling Mode

In the heat pump cycle 10a in the single cooling mode, the control device 70 brings the cooling expansion valve 14b into the throttle state and brings the cooling expansion valve 14d into the fully closed state. The control device 70 closes the fourth on-off valve 15d and opens the fifth on-off valve 15e.

Therefore, in the heat pump cycle 10a in the single cooling mode, the refrigerant circuit is switched to a refrigerant circuit in which the refrigerant discharged from the compressor 11 circulates in an order of the refrigerant passage of the water-refrigerant heat exchanger 121, the receiver 22, the cooling expansion valve 14b, the interior evaporator 18, the evaporation pressure adjustment valve 20, and the suction port side of the compressor 11.

The control device 70 controls the operation of the cooling expansion valve 14b such that a superheat degree SH of a suction refrigerant sucked into the compressor 11 approaches a predetermined reference superheat degree KSH (5° C. in the present embodiment). The control device 70 detects the superheat degree SH based on the evaporator temperature Tefin and the chiller side refrigerant pressure Pc.

In the low-temperature side heating medium circuit 30a in the single cooling mode, the control device 70 operates the low-temperature side heating medium pump 31a to exhibit a predetermined reference pumping capacity. The control device 70 controls the operations of the first low-temperature side heating medium three-way valve 32a and the second low-temperature side heating medium three-way valve 32b such that the low-temperature side heating medium temperature TWL detected by the low-temperature side heating medium temperature sensor 73a approaches a predetermined reference low-temperature side heating medium temperature KTWL.

In the high-temperature side heating medium circuit 30b in the single cooling mode, the control device 70 operates the high-temperature side heating medium pump 31b to exhibit the predetermined reference pumping capacity. The control device 70 controls the operation of the high-temperature side heating medium three-way valve 32c such that the high-temperature side heating medium temperature TWH detected by the high-temperature side heating medium temperature sensor 73b approaches a predetermined reference high-temperature side heating medium temperature KTWH.

In the interior air conditioning unit 50 in the single cooling mode, the control device 70 controls the operation of each control target device as in the single cooling mode described in the first embodiment. Further, the control device 70 controls the operations of other control target devices in the same manner as in the single cooling mode described in the first embodiment.

Therefore, in the heat pump cycle 10a in the single cooling mode, a vapor compression refrigeration cycle is implemented in which the water-refrigerant heat exchanger 121 functions as the condenser and the interior evaporator 18 functions as the evaporator.

In the water-refrigerant heat exchanger 121, the heat of the refrigerant is dissipated to the high-temperature side heating medium. Accordingly, the high-temperature side heating medium is heated. In the interior evaporator 18, the refrigerant absorbs heat from the blown air and evaporates. Accordingly, the blown air is cooled.

In the low-temperature side heating medium circuit 30a in the single cooling mode, as in the first embodiment, the low-temperature side heating medium pumped from the low-temperature side heating medium pump 31a flows into the heating medium passage of the chiller 19. Since the refrigerant does not flow through the refrigerant passage, the heating medium flowing into the heating medium passage of the chiller 19 flows out from the chiller 19 without changing the temperature.

The heating medium flowing out from the chiller 19 flows into the coolant passage 80a of the battery 80 according to the opening degree of the second low-temperature side heating medium three-way valve 32b. Accordingly, the battery 80 is cooled. The flow of the low-temperature side heating medium flowing out from the coolant passage 80a and the flow of the low-temperature side heating medium flowing out from the battery bypass passage 35b merge at the second heating medium three-way joint 33b.

The heating medium flowing out from the second heating medium three-way joint 33b flows into the low-temperature side radiator 34a according to the opening degree of the first low-temperature side heating medium three-way valve 32a. Accordingly, as in the first embodiment, the heat of the low-temperature side heating medium is dissipated to the outside air. The flow of the low-temperature side heating medium flowing out from the low-temperature side radiator 34a and the flow of the low-temperature side heating medium flowing out from the radiator bypass passage 35a merge at the first heating medium three-way joint 33a.

The heating medium flowing out from the first heating medium three-way joint 33a is sucked into the low-temperature side heating medium pump 31a and pumped toward the heating medium passage of the chiller 19.

In the high-temperature side heating medium circuit 30b in the single cooling mode, the high-temperature side heating medium pumped from the high-temperature side heating medium pump 31b flows into the heating medium passage of the water-refrigerant heat exchanger 121. The high-temperature side heating medium flowing into the water-refrigerant heat exchanger 121 exchanges heat with the refrigerant flowing through the refrigerant passage and is heated. The high-temperature side heating medium flowing out from the water-refrigerant heat exchanger 121 flows into the heater core 36 and the high-temperature side radiator 34b according to the opening degree of the high-temperature side heating medium three-way valve 32c.

The high-temperature side heating medium flowing into the heater core 36 dissipates heat to the blown air. Accordingly, the blown air is heated. The high-temperature side heating medium flowing into the high-temperature side radiator 34b dissipates heat to the outside air. The flow of the high-temperature side heating medium flowing out from the heater core 36 and the flow of the high-temperature side heating medium flowing out from the high-temperature side radiator 34b merge at the third heating medium three-way joint 33c.

The heating medium flowing out from the third heating medium three-way joint 33c is sucked into the high-temperature side heating medium pump 31b and pumped toward the heating medium passage of the water-refrigerant heat exchanger 121.

In the interior air conditioning unit 50 in the single cooling mode, as in the single cooling mode in the first embodiment, the blown air whose temperature is adjusted in the mixing space 56 is blown out to an appropriate location in the vehicle interior. Accordingly, the vehicle interior is cooled.

(a-2) Cool-Form Cooling Mode

In the heat pump cycle 10a in the cool-form cooling mode, the control device 70 brings the cooling expansion valve 14b into the throttle state and brings the cooling expansion valve 14d into the throttle state. The control device 70 closes the fourth on-off valve 15d and opens the fifth on-off valve 15e.

Therefore, in the heat pump cycle 10a in the cool-form cooling mode, the refrigerant circuit is switched to a refrigerant circuit in which the refrigerant discharged from the compressor 11 circulates in an order of the refrigerant passage of the water-refrigerant heat exchanger 121, the receiver 22, the cooling expansion valve 14b, the interior evaporator 18, the evaporation pressure adjustment valve 20, and the suction port side of the compressor 11. At the same time, the refrigerant circuit is switched to a refrigerant circuit in which the refrigerant discharged from the compressor 11 circulates in an order of the refrigerant passage of the water-refrigerant heat exchanger 121, the receiver 22, the cooling expansion valve 14d, the refrigerant passage of the chiller 19, and the suction port side of the compressor 11. That is, in the cool-form cooling mode, the interior evaporator 18 and the chiller 19 are switched to the refrigerant circuit connected in parallel to the refrigerant flow.

The control device 70 controls the throttle opening degree of the cooling expansion valve 14d to be a predetermined throttle opening degree for the cool-form cooling mode. Further, the control device 70 controls the operations of other control target devices in the same manner as in the single cooling mode.

Therefore, in the heat pump cycle 10a in the cool-form cooling mode, a vapor compression refrigeration cycle is implemented in which the water-refrigerant heat exchanger 121 functions as the condenser and the interior evaporator 18 and the chiller 19 function as the evaporators.

In the water-refrigerant heat exchanger 121, the high-temperature side heating medium is heated as in the single cooling mode. In the interior evaporator 18, the blown air is cooled as in the single cooling mode. Further, in the chiller 19, the refrigerant absorbs heat from the low-temperature side heating medium and evaporates. Accordingly, the low-temperature side heating medium is cooled.

In the low-temperature side heating medium circuit 30a in the cool-form cooling mode, the heating medium pumped from the low-temperature side heating medium pump 31a flows into the heating medium passage of the chiller 19. The low-temperature side heating medium flowing into the heating medium passage of the chiller 19 is cooled by being absorbed by the refrigerant. The low-temperature side heating medium cooled by the chiller 19 flows into the coolant passage 80a of the battery 80. Accordingly, the battery 80 is cooled. Other operations are the same as those in the single cooling mode.

Therefore, in the cool-form cooling mode, the vehicle interior can be cooled as in the single cooling mode. Further, in the cool-form cooling mode, the battery 80 can be cooled using the cooling capacity of the heat pump cycle 10a.

(c-1) Desorption Heating Mode

In the heat pump cycle 10a in the desorption heating mode, the control device 70 brings the cooling expansion valve 14b into the throttle state and brings the cooling expansion valve 14d into the throttle state. The control device 70 opens the fourth on-off valve 15d and closes the fifth on-off valve 15e.

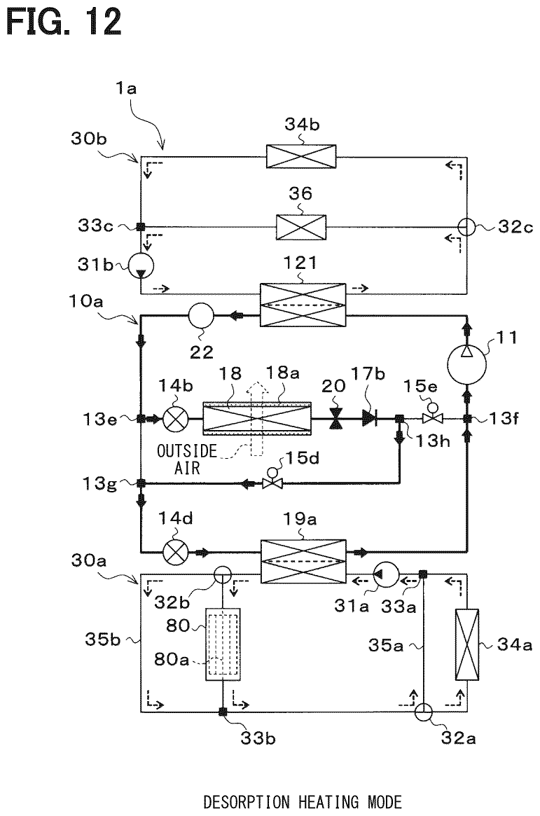

Therefore, in the heat pump cycle 10a in the desorption heating mode, as indicated by black arrows in FIG. 12, the refrigerant circuit is switched to a refrigerant circuit in which the refrigerant discharged from the compressor 11 circulates in an order of the refrigerant passage of the water-refrigerant heat exchanger 121, the receiver 22, the cooling expansion valve 14b, the interior evaporator 18, the cooling expansion valve 14d, the refrigerant passage of the chiller 19, and the suction port side of the compressor 11.

The control device 70 controls the throttle opening degree of the cooling expansion valve 14b so that the evaporator temperature Tefin approaches the reference desorption temperature KTe1. The control device 70 controls the operation of the cooling expansion valve 14d such that the superheat degree SH of the suction refrigerant sucked into the compressor 11 approaches the predetermined reference superheat degree KSH (5° C. in the present embodiment). The control device 70 detects the superheat degree SH based on the chiller side refrigerant temperature Tc and the chiller side refrigerant pressure Pc.

In the low-temperature side heating medium circuit 30a and the high-temperature side heating medium circuit 30b in the desorption heating mode, the control device 70 controls the operation of each control target device as in the cool-form cooling mode. In the high-temperature side heating medium circuit 30b in the heating mode, the operation of the high-temperature side heating medium three-way valve 32c is controlled such that the high-temperature side heating medium flows into at least the heater core 36.

In the interior air conditioning unit 50 in the desorption heating mode, the control device 70 controls the operation of each control target device in the same manner as in the desorption heating mode described in the first embodiment. Further, the control device 70 controls the operations of other control target devices in the same manner as in the desorption heating mode described in the first embodiment.

Therefore, in the heat pump cycle 10a in the desorption heating mode, a vapor compression refrigeration cycle is implemented in which the water-refrigerant heat exchanger 121 and the interior evaporator 18 function as the condensers and the chiller 19 functions as the evaporator.

In the water-refrigerant heat exchanger 121, the high-temperature side heating medium is heated as in the single cooling mode. In the interior evaporator 18, as in the desorption heating mode described in the first embodiment, the temperature of the adsorbent 18a increases, and the moisture adsorbed by the adsorbent 18a is desorbed. In the chiller 19, the low-temperature side heating medium is cooled as in the cool-form cooling mode.

The low-temperature side heating medium circuit 30a and the high-temperature side heating medium circuit 30b in the desorption heating mode operate in the same manner as in the cool-form cooling mode. Other operations are the same as those in the desorption heating mode described in the first embodiment.

Therefore, in the desorption heating mode, the vehicle interior can be heated while desorbing the adsorbent 18a. Further, in the desorption heating mode in the present embodiment, the battery 80 can be cooled using the cooling capacity of the heat pump cycle 10a.

(c-2) Inside Air Adsorption Heating Mode

In the heat pump cycle 10a in the inside air adsorption heating mode, the control device 70 brings the cooling expansion valve 14b into the fully closed state and brings the cooling expansion valve 14d into the throttle state. The control device 70 closes the fourth on-off valve 15d and closes the fifth on-off valve 15e.

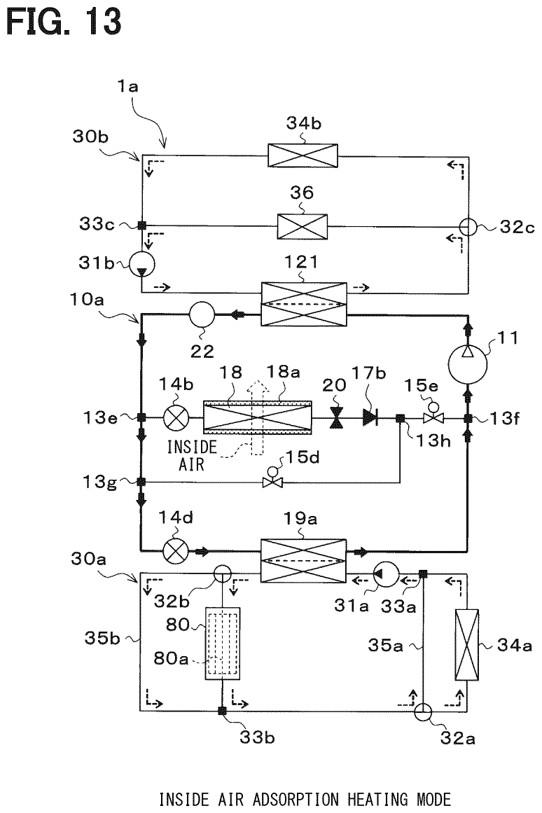

Therefore, in the heat pump cycle 10a in the inside air adsorption heating mode, as indicated by black arrows in FIG. 13, the refrigerant circuit is switched to a refrigerant circuit in which the refrigerant discharged from the compressor 11 circulates in an order of the refrigerant passage of the water-refrigerant heat exchanger 121, the receiver 22, the cooling expansion valve 14d, the refrigerant passage of the chiller 19, and the suction port side of the compressor 11.

The control device 70 controls the operation of the cooling expansion valve 14d such that the superheat degree SH of the suction refrigerant sucked into the compressor 11 approaches the predetermined reference superheat degree KSH (5° C. in the present embodiment), similarly to the desorption heating mode.

In the low-temperature side heating medium circuit 30a and the high-temperature side heating medium circuit 30b in the inside air adsorption heating mode, the control device 70 controls the operation of each control target device similarly to the cool-form cooling mode.

In the interior air conditioning unit 50 in the inside air adsorption heating mode, the control device 70 controls the operation of each control target device in the same manner as in the inside air adsorption heating mode described in the first embodiment. Further, the control device 70 controls the operations of other control target devices in the same manner as in the cooled inside air adsorption heating mode described in the first embodiment.

Therefore, in the heat pump cycle 10a in the inside air adsorption heating mode, a vapor compression refrigeration cycle is implemented in which the water-refrigerant heat exchanger 121 functions as the condenser and the chiller 19 functions as the evaporator.

In the water-refrigerant heat exchanger 121, the high-temperature side heating medium is heated as in the single cooling mode. In the chiller 19, the low-temperature side heating medium is cooled as in the cool-form cooling mode.

The low-temperature side heating medium circuit 30a and the high-temperature side heating medium circuit 30b in the inside air adsorption heating mode operate in the same manner as in the cool-form cooling mode. Other operations are the same as those in the inside air adsorption heating mode described in the first embodiment.

Therefore, in the inside air adsorption heating mode, the moisture contained in the inside air can be adsorbed by the adsorbent 18a to dehumidify and heat the vehicle interior. Further, in the inside air adsorption heating mode, similarly to the cool-form cooling mode, the battery 80 can be cooled using the cooling capacity of the heat pump cycle 10a.

(c-3) Low-Temperature Adsorption Heating Mode

In the heat pump cycle 10a in the low-temperature adsorption heating mode, the control device 70 brings the cooling expansion valve 14b into the throttle state and brings the cooling expansion valve 14d into the throttle state. The control device 70 closes the fourth on-off valve 15d and opens the fifth on-off valve 15e.

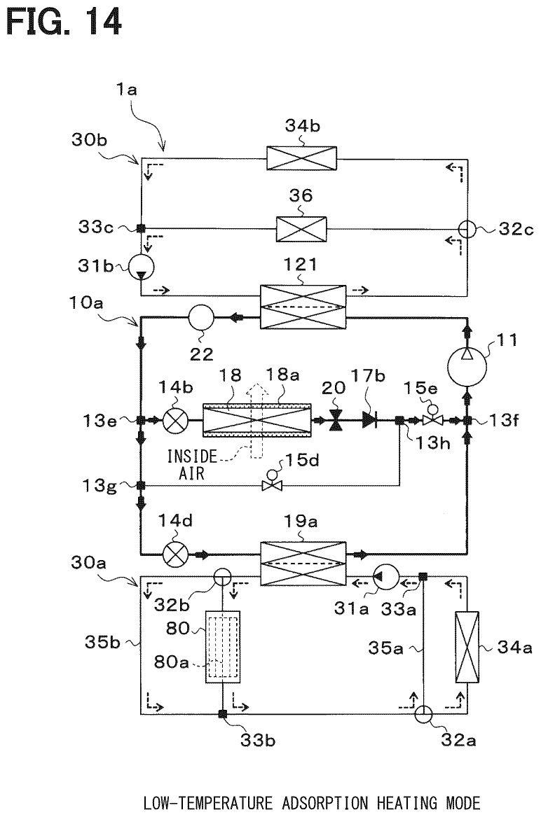

Therefore, in the heat pump cycle 10a in the low-temperature adsorption heating mode, as indicated by black arrows in FIG. 14, the refrigerant circuit is switched to the same refrigerant circuit as in the cool-form cooling mode. That is, in the low-temperature adsorption heating mode, the interior evaporator 18 and the chiller 19 are switched to the refrigerant circuit connected in parallel to the refrigerant flow.

The control device 70 controls the throttle opening degree of the cooling expansion valve 14b so that the evaporator temperature Tefin approaches the inside air temperature Tr.

In the low-temperature side heating medium circuit 30a and the high-temperature side heating medium circuit 30b in the low-temperature adsorption heating mode, the control device 70 controls the operation of each control target device in the same manner as in the desorption heating mode.

In the interior air conditioning unit 50 in the low-temperature adsorption heating mode, the control device 70 controls the operation of each control target device in the same manner as in the low-temperature adsorption heating mode described in the first embodiment. Further, the control device 70 controls the operation of other control target devices in the same manner as in the cooled low-temperature adsorption heating mode described in the first embodiment.

Therefore, in the heat pump cycle 10a in the low-temperature adsorption heating mode, a vapor compression refrigeration cycle is implemented in which the water-refrigerant heat exchanger 121 functions as the condenser and the interior evaporator 18 and the chiller 19 function as the evaporators.

In the water-refrigerant heat exchanger 121, the high-temperature side heating medium is heated as in the single cooling mode. In the interior evaporator 18, the adsorbent 18a is cooled to approach the inside air temperature Tr. Further, in the chiller 19, the refrigerant absorbs heat from the low-temperature side heating medium and evaporates. Accordingly, the low-temperature side heating medium is cooled.

The low-temperature side heating medium circuit 30a and the high-temperature side heating medium circuit 30b in the low-temperature adsorption heating mode operate in the same manner as in the cool-form cooling mode. Other operations are the same as those in the cooled low-temperature adsorption heating mode described in the first embodiment.

Therefore, in the low-temperature adsorption heating mode, the adsorption amount of the adsorbent 18a can be increased more than in the inside air adsorption heating mode, and the vehicle interior can be dehumidified and heated. Further, in the low-temperature adsorption heating mode, similarly to the cool-form cooling mode, the battery 80 can be cooled using the cooling capacity of the heat pump cycle 10a.

As described above, according to the vehicle air conditioning device 1a in the present embodiment, by switching the operation mode, it is possible to achieve comfortable air conditioning in the vehicle interior and appropriate temperature adjustment of the battery 80 which is an in-vehicle device. Further, in the heating mode of the vehicle air conditioning device 1a in the present embodiment, the same effects as those of the first embodiment can be obtained.

That is, in the inside air adsorption heating mode and the low-temperature adsorption heating mode, the inside air having a temperature higher than that of the outside air is introduced as the blown air, so that the energy consumed for heating the blown air in the heater can be reduced. In the inside air adsorption heating mode, energy is not consumed to cause the low-temperature refrigerant to flow into the interior evaporator 18.

Therefore, according to the vehicle air conditioning device 1a in the present embodiment, it is possible to sufficiently reduce energy consumed when heating the vehicle interior while dehumidifying the blown air.

### Third Embodiment

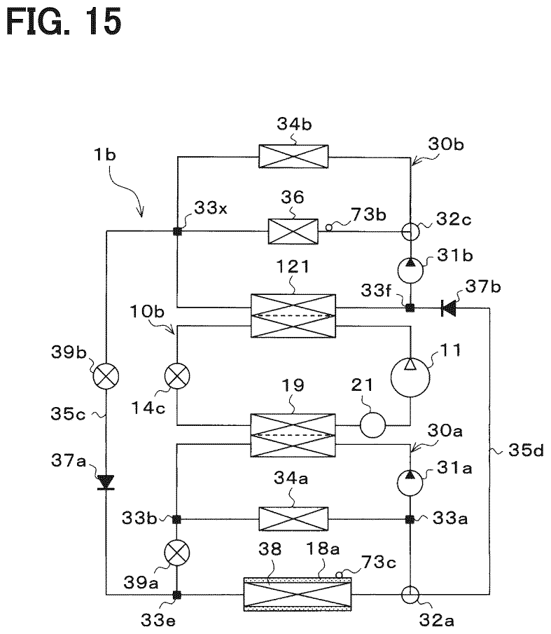

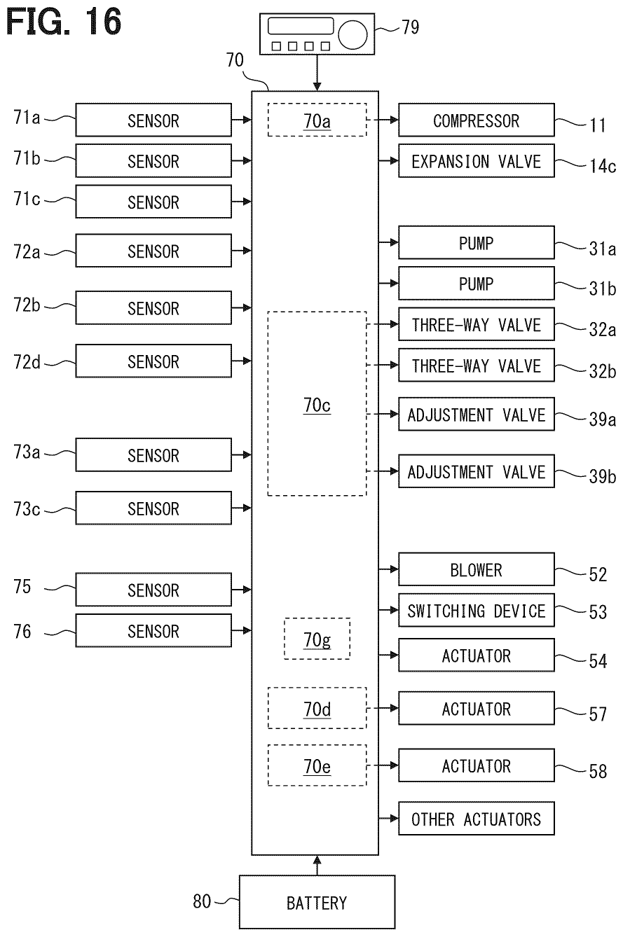

In the present embodiment, a vehicle air conditioning device 1b shown in an overall configuration diagram of FIG. 15 will be described. The vehicle air conditioning device 1b includes a heat pump cycle 10b, the low-temperature side heating medium circuit 30a, the high-temperature side heating medium circuit 30b, the interior air conditioning unit 50, and the like. In FIG. 15, the interior air conditioning unit 50 is omitted for clarity of illustration.

In the heat pump cycle 10b, the receiver 22, the cooling expansion valve 14d, the fourth on-off valve 15d, the fifth on-off valve 15e, the interior evaporator 18, and the like are eliminated from the heat pump cycle 10a described in the second embodiment.

Therefore, in the heat pump cycle 10b, an inlet side of the refrigerant passage of the water-refrigerant heat exchanger 121 is connected to a dispensing port of the compressor 11. An inlet side of the cooling expansion valve 14c is connected to an outlet of the refrigerant passage of the water-refrigerant heat exchanger 121. Therefore, the cooling expansion valve 14c according to the present embodiment is a refrigerant pressure reducer that reduces a pressure of the refrigerant flowing out from the water-refrigerant heat exchanger 121 that is the high-temperature side heating medium heat exchanger.

An inlet side of the accumulator 21 is connected to an outlet of the cooling expansion valve 14c. A suction port side of the compressor 11 is connected to a gas phase refrigerant outlet of the accumulator 21.

The high-temperature side heating medium circuit 30b and the low-temperature side heating medium circuit 30a in the present embodiment are implemented to be connectable via a high-temperature side heating medium passage 35c and a low-temperature side heating medium passage 35d.

Therefore, in the low-temperature side heating medium circuit 30a in the present embodiment, the inflow port side of the second heating medium three-way joint 33b is connected to the outlet of the heating medium passage of the chiller 19, as compared with the second embodiment. The heating medium inlet side of the low-temperature side radiator 34a is connected to one outflow port of the second heating medium three-way joint 33b. One inflow port side of the first heating medium three-way joint 33a is connected to the heating medium outlet of the low-temperature side radiator 34a.

An inlet side of a first heating medium flow rate adjustment valve 39a is connected to the other outflow port of the second heating medium three-way joint 33b. The first heating medium flow rate adjustment valve 39a adjusts a flow rate of the refrigerant flowing from a second heating medium three-way joint 33b side to a fifth heating medium three-way joint 33e side. The basic configuration of the first heating medium flow rate adjustment valve 39a is the same as that of the cooling expansion valve 14c for the refrigerant and the like. The first heating medium flow rate adjustment valve 39a has a fully open function and a fully closed function.

Further, the vehicle air conditioning device 1b in the present embodiment includes a second heating medium flow rate adjustment valve 39b as described later. The basic configuration of the second heating medium flow rate adjustment valve 39b is the same as that of the first heating medium flow rate adjustment valve 39a.

Therefore, the first heating medium flow rate adjustment valve 39a and the second heating medium flow rate adjustment valve 39b can switch the circuit configuration of the heating medium circuit by exhibiting the fully closed function. Therefore, the cooling expansion valve 14b and the cooling expansion valve 14c also function as the heating medium circuit switching valve.

Of course, the first heating medium flow rate adjustment valve 39a and the second heating medium flow rate adjustment valve 39b may be formed by combining a variable throttle mechanism that does not have a fully closed function and an on-off valve that opens and closes the throttle passage. In this case, the on-off valve serves as the heating medium circuit switching valve.

One inflow port side of the fifth heating medium three-way joint 33e is connected to the outlet of the first heating medium flow rate adjustment valve 39a. The heating medium inlet side of a cooler core 38 is connected to the outflow port of the fifth heating medium three-way joint 33e.

Similarly to the interior evaporator 18 described in the first embodiment, the cooler core 38 is disposed in the air conditioning case 51 of the interior air conditioning unit 50. The cooler core 38 is a heating medium-air heat exchanger that exchanges heat between the heating medium flowing out from at least one of the water-refrigerant heat exchanger 121 and the chiller 19 and the air blown from the blower 52.

In the present embodiment, a tank-and-tube heat exchanger is employed as the cooler core 38. A solid layer of the adsorbent 18a similar to that of the first embodiment is disposed in a heat exchange core part of the cooler core 38. That is, the cooler core 38 has an adsorber. An inflow port side of the low-temperature side heating medium three-way valve 32a is connected to a heating medium outlet of the cooler core 38.

The other inflow port side of the first heating medium three-way joint 33a is connected to one outflow port of the low-temperature side heating medium three-way valve 32a. An inlet of the low-temperature side heating medium passage 35d is connected to the other outflow port of the low-temperature side heating medium three-way valve 32a. One inflow port of a sixth heating medium three-way joint 33f is connected to an outlet of the low-temperature side heating medium passage 35d.

In the high-temperature side heating medium circuit 30b in the present embodiment, the inflow port side of the high-temperature side heating medium three-way valve 32c is connected to a dispensing port of the high-temperature side heating medium pump 31b as compared with the second embodiment. One inflow port of a heating medium four-way joint 33x is connected to the heating medium outlet of the heater core 36. Another inflow port of the heating medium four-way joint 33x is connected to the heating medium outlet of the high-temperature side radiator 34b.

The basic configuration of the heating medium four-way joint 33x is the same as that of the four-way joint 13x for the refrigerant. The inlet side of the heating medium passage of the water-refrigerant heat exchanger 121 is connected to one outflow port of the heating medium four-way joint 33x. An inlet of the high-temperature side heating medium passage 35c is connected to another outflow port of the heating medium four-way joint 33x. The other inflow port of the fifth heating medium three-way joint 33e is connected to the outlet of the high-temperature side heating medium passage 35c.

The other inflow port side of the sixth heating medium three-way joint 33f is connected to the outlet of the heating medium passage of the water-refrigerant heat exchanger 121. The suction port side of the high-temperature side heating medium pump 31b is connected to the outflow port of the sixth heating medium three-way joint 33f.

The second heating medium flow rate adjustment valve 39b and a first heating medium check valve 37a are disposed in the high-temperature side heating medium passage 35c. The first heating medium check valve 37a allows the heating medium to flow from a heating medium four-way joint 33x side to a fifth heating medium three-way joint 33e side, and prohibits the heating medium from flowing from the fifth heating medium three-way joint 33e side to the heating medium four-way joint 33x side.

A second heating medium check valve 37b is disposed in the low-temperature side heating medium passage 35d connecting the other outflow port of the low-temperature side heating medium three-way valve 32a and the other inflow port of the sixth heating medium three-way joint 33f. The second heating medium check valve 37b allows the heating medium to flow from the low-temperature side heating medium three-way valve 32a side to the sixth heating medium three-way joint 33f side, and prohibits the heating medium from flowing from the sixth heating medium three-way joint 33f side to the low-temperature side heating medium three-way valve 32a side.

Here, the vehicle air conditioning device 1b according to the present embodiment does not have a function of adjusting the temperature of in-vehicle device. Therefore, the coolant passage 80a of the battery 80 is not connected to the low-temperature side heating medium circuit 30a in the present embodiment.

Next, an electric controller of the vehicle air conditioning device 1b will be described. In the present embodiment, as shown in FIG. 16, a high-temperature side heating medium temperature sensor 73b and a cooler core temperature sensor 73c are added as control sensors connected to the control device 70.

The cooler core temperature sensor 73c is a cooler core temperature detection part that detects a cooler core temperature Tcfin, which is the temperature of the cooler core 38. Specifically, the cooler core temperature sensor 73c detects a heat exchange fin temperature of the cooler core 38. Therefore, a detection part similar to the evaporator temperature sensor 72f can be employed as the cooler core temperature sensor 73c.

The high-pressure side refrigerant temperature and pressure sensor 72b in the present embodiment detects a temperature and a pressure of the refrigerant flowing out from the water-refrigerant heat exchanger 121 and flowing into the cooling expansion valve 14c. Other configurations are the same as those of the vehicle air conditioning device 1 in the first embodiment.

Next, the operation of the vehicle air conditioning device 1b according to the present embodiment will be described. In the vehicle air conditioning device 1b, various operation modes can be switched. Specifically, the vehicle air conditioning device 1b can switch between a cooling mode and a heating mode. Further, in the control program according to the present embodiment, the desorption heating mode, the inside air adsorption heating mode, and the low-temperature adsorption heating mode are selected as the heating mode under the same conditions as in the first embodiment. Hereinafter, each operation mode will be described.

### (a) Cooling Mode

In the heat pump cycle 10b in the cooling mode, the refrigerant discharged from the compressor 11 circulates in an order of the refrigerant passage of the water-refrigerant heat exchanger 121, the cooling expansion valve 14c, the refrigerant passage of the chiller 19, the accumulator 21, and the suction port side of the compressor 11.

The control device 70 controls the refrigerant dispensing capacity of the compressor 11 so that the chiller side refrigerant temperature Tc approaches a target chiller temperature TCO. The target chiller temperature TCO is determined based on the target blowing temperature TAO with reference to the control map stored in advance in the control device 70. In the control map, the target chiller temperature TCO is increased as the target blowing temperature TAO increases.

The control device 70 controls the throttle opening degree of the cooling expansion valve 14c so that the subcool degree SC1 of the refrigerant flowing into the cooling expansion valve 14c approaches the target subcool degree SCO1 determined similarly to the first embodiment.

On the low-temperature side heating medium circuit 30a side in the cooling mode, the control device 70 operates the low-temperature side heating medium pump 31a to exhibit a predetermined reference pumping capacity. The control device 70 brings the first heating medium flow rate adjustment valve 39a into a flow rate adjustment state. In addition, the control device 70 controls the operation of the low-temperature side heating medium three-way valve 32a such that a total flow rate of the heating medium flowing into the inside flows out to a first heating medium three-way joint 33a side.

On the high-temperature side heating medium circuit 30b side in the cooling mode, the control device 70 operates the high-temperature side heating medium pump 31b to exhibit the predetermined reference pumping capacity. The control device 70 controls the operation of the high-temperature side heating medium three-way valve 32c such that the high-temperature side heating medium temperature TWH approaches the predetermined reference high-temperature side heating medium temperature KTWH. The control device 70 brings the second heating medium flow rate adjustment valve 39b into the fully closed state.

Therefore, in the low-temperature side heating medium circuit 30a and the high-temperature side heating medium circuit 30b in the cooling mode, the heating medium circuit is switched to a heating medium circuit in which the heating medium pumped from the low-temperature side heating medium pump 31a circulates in an order of the heating medium passage of the chiller 19, the cooler core 38, and the suction port side of the low-temperature side heating medium pump 31a. At the same time, the heating medium circuit is switched to a heating medium circuit in which the heating medium pumped from the low-temperature side heating medium pump 31a circulates in an order of the heating medium passage of the chiller 19, the low-temperature side radiator 34a, and the suction port side of the low-temperature side heating medium pump 31a.

Further, the heating medium circuit is switched to a heating medium circuit in which the heating medium pumped from the high-temperature side heating medium pump 31b circulates in an order of at least one of the heater core 36 and the high-temperature side radiator 34b, the heating medium passage of the water-refrigerant heat exchanger 121, and the suction port side of the high-temperature side heating medium pump 31b.

The control device 70 adjusts the opening degree of the first heating medium flow rate adjustment valve 39a so that the cooler core temperature Tcfin becomes a target cooler core temperature TCO1. The target cooler core temperature TCO1 is determined based on the target blowing temperature TAO with reference to the control map stored in advance in the control device 70. In the control map, the target cooler core temperature TCO1 is increased as the target blowing temperature TAO increases.

In the interior air conditioning unit 50 in the cooling mode, the control device 70 controls the operation of each control target device as in the single cooling mode described in the first embodiment. Further, the control device 70 controls the operations of other control target devices in the same manner as in the single cooling mode described in the first embodiment.

Therefore, in the heat pump cycle 10b in the cooling mode, a vapor compression refrigeration cycle is implemented in which the water-refrigerant heat exchanger 121 functions as the condenser and the chiller 19 functions as the evaporator.

In the water-refrigerant heat exchanger 121, the heat of the refrigerant is dissipated to the heating medium. Accordingly, the heating medium flowing through the water-refrigerant heat exchanger 121 is heated. In the chiller 19, the refrigerant absorbs heat from the heating medium and evaporates. Accordingly, the heating medium flowing through the chiller 19 is cooled.

On the low-temperature side heating medium circuit 30a side in the cooling mode, the heating medium flowing out from the first heating medium three-way joint 33a is sucked into the low-temperature side heating medium pump 31a. The heating medium pumped from the low-temperature side heating medium pump 31a flows into the heating medium passage of the chiller 19 and is cooled. The heating medium flowing out from the heating medium passage of the chiller 19 flows into the cooler core 38 and the low-temperature side radiator 34a according to the opening degree of the first heating medium flow rate adjustment valve 39a.

The heating medium flowing into the cooler core 38 exchanges heat with the blown air. Accordingly, the blown air is cooled. The heating medium flowing into the low-temperature side radiator 34a absorbs heat from the outside air. In the cooling mode, the total flow rate of the heating medium flowing into the low-temperature side heating medium three-way valve 32a flows out to the first heating medium three-way joint 33a side.

The flow of the heating medium flowing out from the cooler core 38 and the flow of the heating medium flowing out from the low-temperature side radiator 34a merge at the first heating medium three-way joint 33a.

On the high-temperature side heating medium circuit 30b side in the cooling mode, the heating medium heated by the water-refrigerant heat exchanger 121 is sucked into the high-temperature side heating medium pump 31b. The heating medium pumped from the high-temperature side heating medium pump 31b flows into the heater core 36 and the high-temperature side radiator 34b according to the opening degree of the high-temperature side heating medium three-way valve 32c.

The heating medium flowing into the heater core 36 dissipates heat to the blown air. Accordingly, the blown air is heated. The heating medium flowing into the high-temperature side radiator 34b dissipates heat to the outside air. The flow of the heating medium flowing out from the heater core 36 and the flow of the heating medium flowing out from the high-temperature side radiator 34b merge at the heating medium four-way joint 33x.

In the cooling mode, since the second heating medium flow rate adjustment valve 39b is brought into the fully closed state, the heating medium flowing out from the heating medium four-way joint 33x flows into the heating medium passage of the water-refrigerant heat exchanger 121 and is heated.

In the interior air conditioning unit 50 in the cooling mode, as in the single cooling mode in the first embodiment, the blown air whose temperature is adjusted in the mixing space 56 is blown out to an appropriate location in the vehicle interior. Accordingly, the vehicle interior is cooled.

(c-1) Desorption Heating Mode

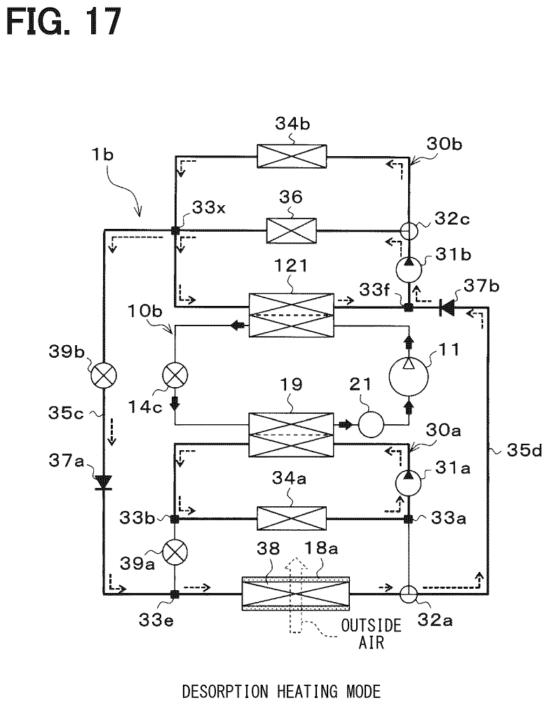

In the heat pump cycle 10b in the desorption heating mode, as indicated by black arrows in FIG. 17, similarly to the cooling mode, the refrigerant discharged from the compressor 11 circulates in an order of the refrigerant passage of the water-refrigerant heat exchanger 121, the cooling expansion valve 14c, the refrigerant passage of the chiller 19, the accumulator 21, and the suction port side of the compressor 11.

The control device 70 controls the refrigerant dispensing capacity of the compressor 11 so that the discharged refrigerant pressure Pd approaches the target high pressure PDO, similarly to the desorption heating mode in the first embodiment. The control device 70 controls the throttle opening degree of the cooling expansion valve 14c so that the subcool degree SC1 of the refrigerant flowing into the cooling expansion valve 14c approaches the target subcool degree SCO1.

On the low-temperature side heating medium circuit 30a side in the desorption heating mode, the control device 70 controls the operation of the low-temperature side heating medium pump 31a as in the cooling mode. The control device 70 brings the first heating medium flow rate adjustment valve 39a into the fully closed state. In addition, the control device 70 controls the operation of the low-temperature side heating medium three-way valve 32a such that the total flow rate of the heating medium flowing into the inside flows out to a sixth heating medium three-way joint 33f side.

On the high-temperature side heating medium circuit 30b side in the desorption heating mode, the control device 70 controls the operations of the high-temperature side heating medium pump 31b and the high-temperature side heating medium three-way valve 32c as in the cooling mode. In the heating mode, the control device 70 controls the operation of the high-temperature side heating medium three-way valve 32c such that the heating medium flows into at least the heater core 36. The control device 70 brings the second heating medium flow rate adjustment valve 39b into the flow rate adjustment state.

Therefore, in the low-temperature side heating medium circuit 30a and the high-temperature side heating medium circuit 30b in the desorption heating mode, as indicated by dashed arrows in FIG. 17, the heating medium circuit is switched to a heating medium circuit in which the heating medium pumped from the low-temperature side heating medium pump 31a circulates in an order of the heating medium passage of the chiller 19, the low-temperature side radiator 34a, and the suction port side of the low-temperature side heating medium pump 31a.

Further, the heating medium circuit is switched to a heating medium circuit in which the heating medium pumped from the high-temperature side heating medium pump 31b circulates at least in an order of the heater core 36, the heating medium passage of the water-refrigerant heat exchanger 121, and the suction port side of the high-temperature side heating medium pump 31b. At the same time, the heating medium circuit is switched to a heating medium circuit in which the heating medium pumped from the high-temperature side heating medium pump 31b circulates at least in an order of the heater core 36, the cooler core 38, and the suction port side of the high-temperature side heating medium pump 31b. That is, in the desorption heating mode, the heating medium circuit is switched to a heating medium circuit in which the heating medium heated in the heating medium passage of the water-refrigerant heat exchanger 121 flows into both the heater core 36 and the cooler core 38 in this order.

The control device 70 controls the opening degree of the second heating medium flow rate adjustment valve 39b such that the cooler core temperature Tcfin approaches the reference desorption temperature KTe1 (50° C. in the present embodiment).

In the interior air conditioning unit 50 in the desorption heating mode, the control device 70 controls the operation of each control target device in the same manner as in the desorption heating mode described in the first embodiment. Further, the control device 70 controls the operations of other control target devices in the same manner as in the desorption heating mode described in the first embodiment.

Therefore, in the heat pump cycle 10b in the desorption heating mode, a vapor compression refrigeration cycle is implemented in which the water-refrigerant heat exchanger 121 functions as the condenser and the chiller 19 functions as the evaporator.

In the water-refrigerant heat exchanger 121, the heating medium flowing through the water-refrigerant heat exchanger 121 is heated as in the cooling mode. In the chiller 19, the heating medium flowing through the chiller 19 is cooled as in the cooling mode.

On the low-temperature side heating medium circuit 30a side in the desorption heating mode, the heating medium pumped from the low-temperature side heating medium pump 31a flows into the heating medium passage of the chiller 19 and is cooled. The heating medium flowing out from the heating medium passage of the chiller 19 flows into the low-temperature side radiator 34a and absorbs heat from the outside air. The heating medium flowing out from the low-temperature side radiator 34a is sucked into the low-temperature side heating medium pump 31a.

On the high-temperature side heating medium circuit 30b side in the desorption heating mode, the heating medium flowing into the heater core 36 dissipates heat to the blown air. Accordingly, the blown air is heated. The heating medium flowing into the high-temperature side radiator 34b dissipates heat to the outside air.

Further, in the desorption heating mode, the second heating medium flow rate adjustment valve 39b is in the flow rate adjustment state. Therefore, the heating medium flowing out from the water-refrigerant heat exchanger 121 flows into the cooler core 38 via at least the heater core 36 and the high-temperature side heating medium passage 35c. Accordingly, the temperature of the adsorbent 18a of the cooler core 38 is increased to approach the reference desorption temperature KTe1, and the moisture adsorbed by the adsorbent 18a is desorbed.

The heating medium flowing out from the cooler core 38 is sucked into the high-temperature side heating medium pump 31b via the low-temperature side heating medium passage 35d. Other operations are the same as those in the desorption heating mode described in the first embodiment.

Therefore, in the desorption heating mode, the vehicle interior can be heated while desorbing the adsorbent 18a.

(c-2) Inside Air Adsorption Heating Mode

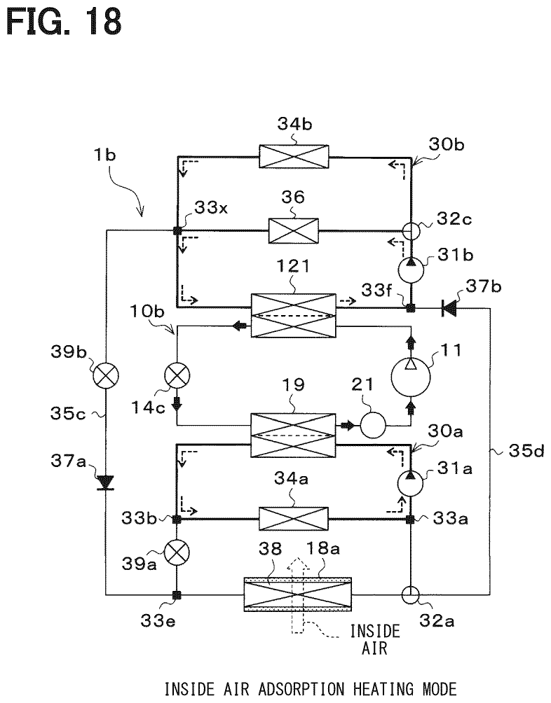

In the heat pump cycle 10b in the inside air adsorption heating mode, as indicated by black arrows in FIG. 18, similarly to the cooling mode, the refrigerant discharged from the compressor 11 circulates in an order of the refrigerant passage of the water-refrigerant heat exchanger 121, the cooling expansion valve 14c, the refrigerant passage of the chiller 19, the accumulator 21, and the suction port side of the compressor 11.

The control device 70 controls the operations of the compressor 11 and the cooling expansion valve 14c as in the desorption heating mode.

On the low-temperature side heating medium circuit 30a side in the inside air adsorption heating mode, the control device 70 controls the operation of the low-temperature side heating medium pump 31a as in the desorption heating mode. The control device 70 brings the second heating medium flow rate adjustment valve 39b into the fully closed state.

On the high-temperature side heating medium circuit 30b side in the inside air adsorption heating mode, the control device 70 controls the operations of the high-temperature side heating medium pump 31b and the high-temperature side heating medium three-way valve 32c as in the desorption heating mode. The control device 70 brings the second heating medium flow rate adjustment valve 39b into the fully closed state.

Therefore, in the low-temperature side heating medium circuit 30a and the high-temperature side heating medium circuit 30b in the inside air adsorption heating mode, as indicated by dashed arrows in FIG. 18, the heating medium circuit is switched to a heating medium circuit in which the heating medium pumped from the low-temperature side heating medium pump 31a circulates in an order of the heating medium passage of the chiller 19, the low-temperature side radiator 34a, and the suction port side of the low-temperature side heating medium pump 31a. That is, in the inside air adsorption heating mode, the heating medium circuit is switched to a heating medium circuit that causes the heating medium cooled in the heating medium passage of the chiller 19 to flow into the low-temperature side radiator 34a.

Further, the heating medium circuit is switched to a heating medium circuit in which the heating medium pumped from the high-temperature side heating medium pump 31b circulates at least in an order of the heater core 36, the heating medium passage of the water-refrigerant heat exchanger 121, and the suction port side of the high-temperature side heating medium pump 31b. That is, in the inside air adsorption heating mode, the heating medium circuit is switched to a heating medium circuit in which the heating medium heated in the heating medium passage of the water-refrigerant heat exchanger 121 flows into the heater core 36.

In the interior air conditioning unit 50 in the inside air adsorption heating mode, the control device 70 controls the operation of each control target device in the same manner as in the inside air adsorption heating mode described in the first embodiment. Further, the control device 70 controls the operations of other control target devices in the same manner as in the single inside air adsorption heating mode described in the first embodiment.

Therefore, in the heat pump cycle 10b in the inside air adsorption heating mode, a vapor compression refrigeration cycle is implemented in which the water-refrigerant heat exchanger 121 functions as the condenser and the chiller 19 functions as the evaporator.

In the water-refrigerant heat exchanger 121, the heating medium flowing through the water-refrigerant heat exchanger 121 is heated as in the desorption heating mode. In the chiller 19, the heating medium flowing through the chiller 19 is cooled as in the desorption heating mode.

On the high-temperature side heating medium circuit 30b side in the inside air adsorption heating mode, the heating medium flowing into the heater core 36 dissipates heat to the blown air as in the desorption heating mode. Accordingly, the blown air is heated. The heating medium flowing into the high-temperature side radiator 34b dissipates heat to the outside air as in the desorption heating mode.

On the low-temperature side heating medium circuit 30a side in the inside air adsorption heating mode, the heating medium pumped from the low-temperature side heating medium pump 31a is cooled by the chiller 19 as in the desorption heating mode. The heating medium cooled by the chiller 19 flows into the low-temperature side radiator 34a and absorbs heat from the outside air. Other operations are the same as those in the inside air adsorption heating mode described in the first embodiment.

Therefore, in the inside air adsorption heating mode, the moisture contained in the inside air can be adsorbed by the adsorbent 18a to dehumidify and heat the vehicle interior.

(c-3) Low-Temperature Adsorption Heating Mode

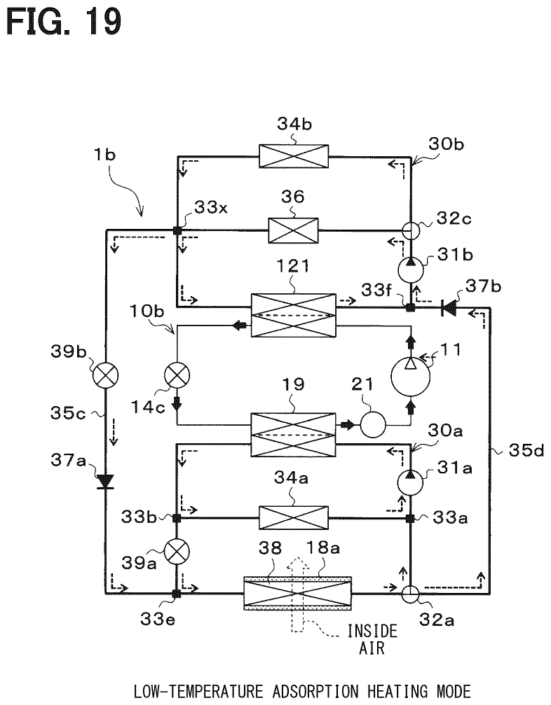

In the heat pump cycle 10b in the low-temperature adsorption heating mode, as indicated by black arrows in FIG. 19, similarly to the cooling mode, the refrigerant discharged from the compressor 11 circulates in an order of the refrigerant passage of the water-refrigerant heat exchanger 121, the cooling expansion valve 14c, the refrigerant passage of the chiller 19, the accumulator 21, and the suction port side of the compressor 11.

The control device 70 controls the operations of the compressor 11 and the cooling expansion valve 14c as in the desorption heating mode.

On the low-temperature side heating medium circuit 30a side in the low-temperature adsorption heating mode, the control device 70 controls the operation of the low-temperature side heating medium pump 31a as in the desorption heating mode. The control device 70 brings the first heating medium flow rate adjustment valve 39a into a flow rate adjustment state.

On the high-temperature side heating medium circuit 30b side in the low-temperature adsorption heating mode, the control device 70 controls the operations of the high-temperature side heating medium pump 31b and the high-temperature side heating medium three-way valve 32c as in the desorption heating mode. The control device 70 brings the second heating medium flow rate adjustment valve 39b into the flow rate adjustment state.

The control device 70 controls the operation of the low-temperature side heating medium three-way valve 32a such that the heating medium flowing into the inside flows out to both the first heating medium three-way joint 33a side and the low-temperature side heating medium passage 35d side.

Therefore, in the high-temperature side heating medium circuit 30b and the low-temperature side heating medium circuit 30a in the low-temperature adsorption heating mode, as indicated by dashed arrows in FIG. 19, the heating medium circuit is switched to a heating medium circuit in which the heating medium pumped from the high-temperature side heating medium pump 31b circulates at least in an order of the heater core 36, the heating medium passage of the water-refrigerant heat exchanger 121, and the suction port side of the high-temperature side heating medium pump 31b. At the same time, similarly to the desorption heating mode, the heating medium circuit is switched to a heating medium circuit in which the heating medium pumped from the high-temperature side heating medium pump 31b circulates at least in an order of the heater core 36, the cooler core 38, and the suction port side of the high-temperature side heating medium pump 31b.

Further, the heating medium circuit is switched to a heating medium circuit in which the heating medium pumped from the low-temperature side heating medium pump 31a circulates in an order of the heating medium passage of the chiller 19, the cooler core 38, and the suction port side of the low-temperature side heating medium pump 31a. At the same time, similarly to the cooling mode, the heating medium circuit is switched to a heating medium circuit in which the heating medium pumped from the low-temperature side heating medium pump 31a circulates in an order of the heating medium passage of the chiller 19, the low-temperature side radiator 34a, and the suction port side of the low-temperature side heating medium pump 31a. That is, in the low-temperature adsorption heating mode, the circuit is switched to the heating medium circuit in which the heating medium heated in the heating medium passage of the water-refrigerant heat exchanger 121 flows into the cooler core 38 and the heating medium cooled in the heating medium passage of the chiller 19 flows into the cooler core 38.

The control device 70 adjusts an opening degree ratio of the first heating medium flow rate adjustment valve 39a and the second heating medium flow rate adjustment valve 39b such that the cooler core temperature Tcfin approaches the inside air temperature Tr. More specifically, the control device 70 increases the opening degree of the first heating medium flow rate adjustment valve 39a and decreases the opening degree of the second heating medium flow rate adjustment valve 39b as a value obtained by subtracting the inside air temperature Tr from the cooler core temperature Tcfin increases.

The control device 70 controls the operation of the low-temperature side heating medium three-way valve 32a according to the opening degree of the second heating medium flow rate adjustment valve 39b. More specifically, the control device 70 decreases the flow rate of the heating medium flowing out to the first heating medium three-way joint 33a side and increases the flow rate of the heating medium flowing out to the low-temperature side heating medium passage 35d side as the opening degree of the second heating medium flow rate adjustment valve 39b increases.

In the interior air conditioning unit 50 in the low-temperature adsorption heating mode, the control device 70 controls the operation of each control target device in the same manner as in the low-temperature adsorption heating mode described in the first embodiment. Further, the control device 70 controls the operation of other control target devices in the same manner as in the single low-temperature adsorption heating mode described in the first embodiment.

Therefore, in the heat pump cycle 10b in the low-temperature adsorption heating mode, a vapor compression refrigeration cycle is implemented in which the water-refrigerant heat exchanger 121 functions as the condenser and the chiller 19 functions as the evaporator.

In the water-refrigerant heat exchanger 121, the heating medium flowing through the water-refrigerant heat exchanger 121 is heated as in the desorption heating mode. In the chiller 19, the heating medium flowing through the chiller 19 is cooled as in the desorption heating mode.

On the high-temperature side heating medium circuit 30b side in the low-temperature adsorption heating mode, the heating medium flowing into the heater core 36 dissipates heat to the blown air as in the desorption heating mode. Accordingly, the blown air is heated. The heating medium flowing into the high-temperature side radiator 34b dissipates heat to the outside air as in the desorption heating mode.

Further, in the high-temperature side heating medium circuit 30b in the low-temperature adsorption heating mode, the second heating medium flow rate adjustment valve 39b is in the flow rate adjustment state. Therefore, the heating medium heated in the heating medium passage of the water-refrigerant heat exchanger 121 flows into one inflow port of the fifth heating medium three-way joint 33e via at least the heater core 36, the high-temperature side heating medium passage 35c, and the like.

On the high-temperature side heating medium circuit 30b side in the low-temperature adsorption heating mode, the heating medium pumped from the low-temperature side heating medium pump 31a is cooled by the chiller 19 as in the desorption heating mode. The heating medium cooled by the chiller 19 flows into the low-temperature side radiator 34a and absorbs heat from the outside air.

Further, in the high-temperature side heating medium circuit 30b in the low-temperature adsorption heating mode, the first heating medium flow rate adjustment valve 39a is in the flow rate adjustment state. Therefore, the heating medium cooled in the heating medium passage of the chiller 19 flows into the other inflow port of the fifth heating medium three-way joint 33e.

In the fifth heating medium three-way joint 33e, a flow of the heating medium flowing in from the water-refrigerant heat exchanger 121 side and a flow of the refrigerant flowing in from the chiller 19 side merge, and the temperature of the heating medium approaches the inside air temperature Tr. The merged heating medium approaching the inside air temperature Tr flows into the cooler core 38. The heating medium flowing into the cooler core 38 absorbs heat from the cooler core 38 and the adsorbent 18a.

Accordingly, the temperature of the deep layer portion (that is, a portion closer to the cooler core 38 than the outer surface) of the adsorbent 18a approaches the inside air temperature Tr. The heating medium flowing out from the cooler core 38 flows out to both the first heating medium three-way joint 33a side and the low-temperature side heating medium passage 35d side according to the opening degree of the low-temperature side heating medium three-way valve 32a. Other operations are the same as those in the low-temperature adsorption heating mode described in the first embodiment.

Therefore, in the low-temperature adsorption heating mode, the adsorption amount of the adsorbent 18a can be increased more than in the inside air adsorption heating mode, and the vehicle interior can be dehumidified and heated.

As described above, according to the vehicle air conditioning device 1b in the present embodiment, it is possible to achieve comfortable air conditioning in the vehicle interior by switching the operation mode. Further, in the heating mode of the vehicle air conditioning device 1b in the present embodiment, the same effects as those of the first embodiment can be obtained.

That is, in the inside air adsorption heating mode and the low-temperature adsorption heating mode, the inside air having a temperature higher than that of the outside air is introduced as the blown air, so that the energy consumed for heating the blown air in the heater can be reduced. In the inside air adsorption heating mode, unnecessary energy is not consumed because the low-temperature heating medium flows into the cooler core 38.

Therefore, according to the vehicle air conditioning device 1b in the present embodiment, it is possible to sufficiently reduce energy to be consumed when heating the vehicle interior while dehumidifying the blown air.

The present disclosure is not limited to the above-described embodiments, and various modifications can be made as follows without departing from the gist of the present disclosure.

In the above-described embodiments, an example in which the air conditioning device according to the present disclosure is applied to a vehicle is described, and the application of a refrigeration cycle device according to the present disclosure is not limited to a vehicle. For example, the present disclosure may be applied to a stationary air conditioning device with a temperature adjustment function of adjusting the temperature of a cooling target (for example, a computer, a server device, or other peripheral devices) while performing interior air conditioning.

In the first and second embodiments described above, the example in which the air conditioning device according to the present disclosure is applied to the air conditioning device with the in-vehicle device temperature adjustment function and the temperature of the battery 80 is adjusted as the in-vehicle device is described, and the in-vehicle device is not limited to the battery 80. For example, the temperature of an inverter, a PCU, a transaxle, a control device for ADAS, or the like may be adjusted. Further, the temperatures of the plurality of in-vehicle devices may be adjusted.

The inverter supplies electric power to a motor generator and the like. The PCU is a power control unit that performs substation and power distribution. The transaxle is a power transmission mechanism in which a transmission, a differential gear, and the like are integrated. The control device for ADAS is a control device for an advanced driver assistance system.

The configuration of the air conditioning device according to the present disclosure is not limited to the configuration disclosed in the above-described embodiments.

In the above-described embodiments, an example in which the evaporation pressure adjustment valve 20 is employed is described, but the present disclosure is not limited thereto. Instead of the evaporation pressure adjustment valve 20, a variable throttle mechanism implemented by an electrical mechanism similar to the heating expansion valve 14a or the like may be employed. The fourth three-way joint 13d and the fifth three-way joint 13e described in the first embodiment may be integrated, and a four-way joint similar to the four-way joint 13x may be employed.

In the above-described embodiments, an example in which the first heating medium flow rate adjustment valve 39a is employed as the heating medium circuit switching valve is described, and the present disclosure is not limited thereto. The first heating medium flow rate adjustment valve 39a may be omitted, and the second low-temperature side heating medium three-way valve 32b may be disposed instead of the second heating medium three-way joint 33b or the fifth heating medium three-way joint 33e.

A control sensor group connected to the input side of the control device 70 is not limited to the detection part disclosed in the above-described embodiments. Various detection parts may be added or changed as necessary. For example, in the above-described embodiment, an example in which the humidity sensor 76 is used as the window fogging detection part is described, and the window fogging detection part is not limited thereto. A condensation sensor, an optical fogging sensor, or the like may be employed as necessary.

Similarly, in the above-described embodiments, the example in which the temperature detection part that detects a heat exchange fin temperature of the cooler core 38 is employed as the cooler core temperature sensor 73c is described, and the present disclosure is not limited thereto. As the cooler core temperature sensor 73c, a temperature detection part that detects a cooler core side heating medium temperature TWC, which is a temperature of the heating medium flowing into the cooler core 38, may be employed.

In the above-described embodiments, an example in which an adsorbent having isothermal adsorption characteristics corresponding to AQSOA (registered trademark) Z05 is employed as the adsorbent 18a is described, and the present disclosure is not limited thereto. For example, an adsorbent having isothermal adsorption characteristics corresponding to AQSOA (registered trademark) Z01 and Z02 may be employed.

In the above-described embodiments, an example in which R1234yf is employed as the refrigerant of the heat pump cycles 10, 10a, and 10b is described, and the present disclosure is not limited thereto. For example, R134a, R600a, R410A, R404A, R32, R407C, or R290 may be employed. Alternatively, a mixture refrigerant or the like in which multiple types of those refrigerants are mixed together may be employed. Furthermore, R744 may be employed as the refrigerant to form a supercritical refrigeration cycle in which the high-pressure side refrigerant pressure is equal to or higher than the critical pressure of the refrigerant.

In addition, in the above-described embodiments, an example in which a PAG oil is employed as the refrigerator oil is described, and the present disclosure is not limited thereto. For example, POE (that is, polyol ester) or the like may be employed.

In the above-described embodiments, the example in which the ethylene glycol aqueous solution is employed as the heating medium of the low-temperature side heating medium circuit 30a and the high-temperature side heating medium circuit 30b is described, and the present disclosure is not limited thereto. For example, a solution containing dimethylpolysiloxane, nanofluid, or the like, an antifreeze, an aqueous liquid refrigerant containing alcohol or the like, or a liquid medium containing oil or the like may be employed.

In the above-described embodiments, the vehicle air conditioning device 1, 1a, 1b capable of switching a plurality of operation modes is described, and the switching of the operation mode is not limited thereto.

When at least the (c-1) desorption heating mode and the (c-2) inside air adsorption heating mode can be switched and executed as the heating mode, it is possible to reduce energy to be consumed when heating the air-conditioning target space while dehumidifying the blown air.

As another operation mode, a parallel dehumidifying heating mode may be executable. For example, in the vehicle air conditioning device 1, 1a, the refrigerant circuit and the heating medium circuit have the same circuit configuration as (c-3) the low-temperature adsorption heating mode, and the refrigerant evaporation temperature in the interior evaporator 18 is lower than the inside air temperature Tr, so that the parallel dehumidifying heating mode can be executed.

Similarly, in the vehicle air conditioning device 1b, the heating medium circuit has the same circuit configuration as the (c-3) low-temperature adsorption heating mode, and the temperature of the heating medium flowing into the cooler core 38 is lower than the inside air temperature Tr, so that the parallel dehumidifying heating mode can be executed.

As another operation mode, a single cooling mode in which the in-vehicle device is cooled without performing air conditioning of the vehicle interior may be executable. For example, in the vehicle air conditioning device 1, the refrigerant circuit is switched to a refrigerant circuit in which the exterior heat exchanger 16 of the heat pump cycle 10 functions as the condenser, and the chiller 19 functions as the evaporator without causing the refrigerant to flow into the interior evaporator 18. Then, the blower 52 may be stopped.

Similarly, in the vehicle air conditioning device 1, the water-refrigerant heat exchanger 121 of the heat pump cycle 10 is switched to a refrigerant circuit that causes the chiller 19 to function as an evaporator without causing the refrigerant to flow into the interior evaporator 18. Then, the blower 52 may be stopped.

Further, as another operation mode, a cooling and heating mode for heating the vehicle interior and cooling the in-vehicle device may be executable. For example, in the vehicle air conditioning device 1, the refrigerant circuit is switched to a refrigerant circuit in which the refrigerant flowing out from the heater circulates in an order of the heating expansion valve 14a, the exterior heat exchanger 16, the cooling expansion valve 14c, the chiller 19, and the suction port side of the compressor 11. Further, the interior condenser 12 may function as the condenser, and the exterior heat exchanger 16 and the chiller 19 may function as the evaporators.

In the above-described embodiments, the example in which the mode is switched to the low-temperature adsorption heating mode when the fogging of the window glass is detected by the window fogging detection part during the execution of the inside air adsorption heating mode is described, and the present disclosure is not limited thereto. For example, when a predetermined reference time elapses from the start of the execution of the inside air adsorption heating mode, it may be determined that the defogging of the vehicle window glass is necessary, and the mode may be switched to the low-temperature adsorption heating mode.

Units disclosed in the embodiment described above may be appropriately combined in an implementable range. For example, the water-refrigerant heat exchanger 121 and the high-temperature side heating medium circuit 30b similar to those in the second embodiment may be employed as the heater in the first embodiment.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. An air conditioning device comprising:
a compressor configured to compress and discharge a refrigerant;
a heater configured to heat blown air to be blown into an air-conditioning target space, using the refrigerant discharged from the compressor as a heat source;
a refrigerant-air heat exchanger configured to exchange heat between the refrigerant and the blown air before being heated by the heater;
a refrigerant-outside air heat exchanger configured to exchange heat between the refrigerant and outside air outside the air-conditioning target space;
an outside air side pressure reducer configured to reduce a pressure of the refrigerant flowing into the refrigerant-outside air heat exchanger;
a refrigerant circuit switching valve configured to switch a refrigerant circuit through which the refrigerant circulates; and
an air blower configured to suck at least inside air from the air-conditioning target space and blow the inside air toward the refrigerant-air heat exchanger as the blown air, wherein
the refrigerant-air heat exchanger includes an adsorber configured to adsorb moisture contained in the blown air,
in a desorption heating mode in which heating of the air-conditioning target space is performed and moisture adsorbed by the adsorber is desorbed, the refrigerant circuit switching valve switches to a circuit in which the refrigerant flowing out from the heater circulates in an order of the refrigerant-air heat exchanger, the outside air side pressure reducer, the refrigerant-outside air heat exchanger, and a suction port of the compressor, and
in an inside air adsorption heating mode in which heating of the air-conditioning target space is performed and moisture is adsorbed by the adsorber, the refrigerant circuit switching valve switches to a circuit in which the refrigerant flowing out from the heater circulates in an order of the outside air side pressure reducer, the refrigerant-outside air heat exchanger, and the suction port of the compressor, bypassing the refrigerant-air heat exchanger, and the air blower blows the inside air as the blown air toward the refrigerant-air heat exchanger.

2. The air conditioning device according to claim 1, further comprising:
a refrigerant-air side pressure reducer configured to reduce the pressure of the refrigerant flowing into the refrigerant-air heat exchanger, wherein
in a low-temperature adsorption heating mode in which heating of the air-conditioning target space is performed and a moisture adsorption amount adsorbed by the adsorber is increased more than in the inside air adsorption heating mode, the refrigerant circuit switching valve switches to a circuit in which the refrigerant flowing out from the heater circulates in an order of the outside air side pressure reducer, the refrigerant-outside air heat exchanger, and the suction port of the compressor, and simultaneously switches to a circuit in which the refrigerant flowing out from the heater circulates in an order of the refrigerant-air side pressure reducer, the refrigerant-air heat exchanger, and the suction port of the compressor, and the air blower blows the inside air as the blown air toward the refrigerant-air heat exchanger.

3. The air conditioning device according to claim 2, wherein
in the low-temperature adsorption heating mode, a temperature of the refrigerant flowing into the refrigerant-air heat exchanger is adjusted to approach an inside air temperature that is a temperature of the inside air.

4. An air conditioning device comprising:
a compressor configured to compress and discharge a refrigerant;
a high-temperature side heating medium heat exchanger configured to exchange heat between the refrigerant discharged from the compressor and a heating medium;
a refrigerant pressure reducer configured to reduce a pressure of the refrigerant flowing out from the high-temperature side heating medium heat exchanger;
a low-temperature side heating medium heat exchanger configured to exchange heat between the refrigerant whose pressure is reduced by the refrigerant pressure reducer and the heating medium;
a high-temperature side air heat exchanger configured to exchange heat between the heating medium flowing out from at least the high-temperature side heating medium heat exchanger and blown air to be blown into an air-conditioning target space;
a heating medium-outside air heat exchanger configured to exchange heat between the heating medium flowing out from at least the low-temperature side heating medium heat exchanger and outside air outside the air-conditioning target space;
a heating medium-air heat exchanger configured to exchange heat between the heating medium flowing out from at least one of the high-temperature side heating medium heat exchanger and the low-temperature side heating medium heat exchanger and the blown air before being heated in the high-temperature side air heat exchanger;
a heating medium circuit switching valve configured to switch a heating medium circuit through which the heating medium circulates; and
an air blower configured to suck at least inside air from the air-conditioning target space and blow the inside air toward the heating medium-air heat exchanger, wherein
the heating medium-air heat exchanger includes an adsorber configured to adsorb moisture contained in the blown air,
in a desorption heating mode in which heating of the air-conditioning target space is performed and moisture adsorbed by the adsorber is desorbed, the heating medium circuit switching valve switches to a heating medium circuit in which the heating medium flowing out from the high-temperature side heating medium heat exchanger flows into the high-temperature side air heat exchanger and the heating medium-air heat exchanger, and
in an inside air adsorption heating mode in which heating of the air-conditioning target space is performed and moisture is adsorbed by the adsorber, the heating medium circuit switching valve causes the heating medium flowing out from the high-temperature side heating medium heat exchanger to flow into the high-temperature side air heat exchanger, and is simultaneously switched to a heating medium circuit in which the heating medium flowing out from the low-temperature side heating medium heat exchanger bypasses the heating medium-air heat exchanger and flows into the heating medium-outside air heat exchanger, and the air blower blows the inside air toward the heating medium-air heat exchanger.

5. The air conditioning device according to claim 4, wherein
in a low-temperature adsorption heating mode in which heating of the air-conditioning target space is performed and a moisture adsorption amount adsorbed by the adsorber is increased more than in the inside air adsorption heating mode, the heating medium circuit switching valve causes the heating medium flowing out from the high-temperature side heating medium heat exchanger to flow into the high-temperature side air heat exchanger and simultaneously causes the heating medium flowing out from the low-temperature side heating medium heat exchanger to flow into the heating medium-air heat exchanger, and the air blower blows the inside air toward the heating medium-air heat exchanger.

6. The air conditioning device according to claim 5, wherein
in the low-temperature adsorption heating mode, a temperature of the heating medium flowing into the heating medium-air heat exchanger is adjusted to approach an inside air temperature that is a temperature of the inside air.

7. The air conditioning device according to claim 2, which is applied to a vehicle, further comprising:
a window fogging detection part configured to detect fogging of a window glass of the vehicle, wherein
when the fogging of the window glass is detected by the window fogging detection part during execution of the inside air adsorption heating mode, the air conditioning device is switched to the low-temperature adsorption heating mode.

8. The air conditioning device according to claim 2, wherein
when a predetermined reference time elapses during execution of the inside air adsorption heating mode, the air conditioning device is switched to the low-temperature adsorption heating mode.

9. The air conditioning device according to claim 1, wherein
the adsorber has a maximum relative pressure ratio Rmax satisfying the following formula:
0.05≤R max≤0.35,
the maximum relative pressure ratio Rmax is a relative pressure ratio at which an increase in an adsorption amount of the adsorber is greatest when the relative pressure ratio is increased by a predetermined amount, and the relative pressure ratio is a ratio of a water vapor partial pressure in air surrounding the adsorber to a saturated water vapor pressure at temperature of the adsorber.
